(19) United States
(12) Patent Application Publication
(10) Pub. No.: US 2026/0352743 A1
(43) Pub. Date: Nov. 5, 2026

(54) SERVER DEVICE, TRANSMISSION-SIDE TERMINAL DEVICE, RECEPTION-SIDE TERMINAL DEVICE, AND MESSAGE TRANSMISSION/RECEPTION SYSTEM

(71) Applicant: NEC Platforms, Ltd., Kawasaki-shi, Kanagawa (JP)

(72) Inventor: Takumi ABE, Kanagawa (JP)

(73) Assignee: NEC Platforms, Ltd., Kawasaki-shi, Kanagawa (JP)

(21) Appl. No.: 19/101,949

(22) PCT Filed: Jul. 5, 2023
(86) PCT No.: PCT/JP2023/024955

§ 371 Date: Feb. 7, 2025

(30) Foreign Application Priority Data
Aug. 18, 2022 (JP) 2022-130539

(51) Int. Cl. H04L 67/62

(52) U.S. Cl. CPC H04L 67/62

(57) ABSTRACT

Confirmation request level data transmitted by a transmission-side terminal device and indicating a request level for confirmation of message data transmitted by the transmission-side terminal device is transmitted, confirmable time period data indicating a time period during which the recipient is able to confirm the message data is acquired from a reception-side terminal device, a scheduled transmission time for transmitting message data corresponding to the confirmation request level data to the reception-side terminal device is selected based on the confirmation request level data and the confirmable time period data, message data transmitted by the transmission-side terminal device and corresponding to the confirmation request level data is received, and the received message data is transmitted to the reception-side terminal device in a case where a time acquired by a clock unit is a time on or after the selected scheduled transmission time.

### TECHNICAL FIELD

The present disclosure relates to a server device, a transmission-side terminal device, a reception-side terminal device, a message transmission/reception system, a message transmission/reception method, a message transmission method, a message reception method, and a program.

### BACKGROUND ART

An instant messenger is application software (hereinafter also referred to as an application program, or simply as an application) for sending and receiving short messages, and has the advantage of enabling quick communication since the time period it takes for the message to reach the receiver's terminal device after being sent by the sender is short. While they have these features, typical instant messengers do not control message transmission based on factors such as the urgency of the message. Therefore, the terminal device of a user who exchanges messages with many people receives messages more frequently. As a result, the time period it takes to review and respond to each received message increases, potentially resulting in a condition known as “chat fatigue.”

In response to this, for example, Patent Document 1 discloses a technology that prevents a notification sound resulting from the reception of a message, such as an e-mail, from being sounded at a time period that is inconvenient for the recipient when the recipient's terminal device receives the message.

### PRIOR ART DOCUMENTS

### Patent Documents

Patent Document 1: Japanese Unexamined Patent Application, First Publication No. 2020-024589

### SUMMARY OF INVENTION

### Problems to be Solved by the Invention

However, the technology disclosed in Patent Document 1 is a technology in which, for example, the sender of a message predicts a time period that will be inconvenient for the recipient, sets the sending time for the message, and the sender's terminal device sends the message at the set sending time. More specifically, if the sender creates a message late at night, the sender expects that the recipient will likely be asleep during that time period and will be able to check the message at 8:00 a.m. the next day. In accordance with this prediction, the sender sets 8:00 a.m. of the following day as the message sending time in the sender's terminal device, and at 8:00 a.m. of the following day, the sender's terminal device sends the message to the receiver's terminal device. Therefore, in a case of using the technology disclosed in Patent Document 1, unless the sender knows exactly what time period the recipient can check the message, there is a problem that the sender cannot send the message while avoiding time periods that are inconvenient for the recipient.

Therefore, an object of this disclosure is to provide a server device, a transmission-side terminal device, a reception-side terminal device, a message transmission/reception system, a message transmission/reception method, a message transmission method, a message reception method, and a program that solve the above problems.

### Means for Solving the Problem

According to a first example aspect of the present disclosure, a server device includes: a confirmation request level reception means for receiving confirmation request level data, transmitted by a transmission-side terminal device, indicating a request level for confirmation of message data transmitted by the transmission-side terminal device; a confirmable time period acquisition means for acquiring from a reception-side terminal device confirmable time period data indicating a time period during which the recipient is able to confirm the message data; a scheduled transmission time selection means for selecting a scheduled transmission time for transmitting message data corresponding to the confirmation request level data to the reception-side terminal device based on the confirmation request level data and the confirmable time period data; a message reception means for receiving message data transmitted by the transmission-side terminal device and corresponding to the confirmation request level data; and a message transmission means for transmitting the message data received by the message reception means to the reception-side terminal device in a case where a time acquired by a clock means is a time on or after the scheduled transmission time selected by the scheduled transmission time selection means.

According to a second example aspect of the present disclosure, a message transmission/reception system includes: a transmission-side terminal device, a reception-side terminal device, and a server device, wherein the transmission-side terminal device includes a confirmation request level designation means for transmitting confirmation request level data designated by the sender and indicating the request level for confirmation of message data to be transmitted, and a message transmission means for transmitting the message data; the reception-side terminal device includes a confirmable time period designation means for designating confirmable time period data indicating a time period during which a recipient is able to confirm the message data; and a message reception means for receiving the message data; and the server device includes a confirmation request level reception means for receiving the confirmation request level data transmitted by the transmission-side terminal device; a confirmable time period acquisition means for acquiring the confirmable time period data from the reception-side terminal device; a scheduled transmission time selection means for selecting a scheduled transmission time for transmitting message data corresponding to the confirmation request level data to the reception-side terminal device based on the confirmation request level data and the confirmable time period data; a message reception means for receiving message data transmitted by the transmission-side terminal device and corresponding to the confirmation request level data; and a message transmission means for transmitting the message data received by the message reception means to the reception-side terminal device in a case where a time acquired from a clock means is a time on or after the scheduled transmission time selected by the scheduled transmission time selection means.

According to a third example aspect of the present disclosure, a message transmission/reception method includes: a confirmation request level reception step of receiving confirmation request level data, transmitted by a transmission-side terminal device, indicating a request level for confirmation of message data transmitted by the transmission-side terminal device; a confirmable time period reception step of acquiring from a reception-side terminal device confirmable time period data indicating a time period during which the recipient is able to confirm the message data; a scheduled transmission time selection step of selecting a scheduled transmission time for transmitting message data corresponding to the confirmation request level data to the reception-side terminal device based on the confirmation request level data and the confirmable time period data; a message reception step of receiving message data, transmitted by the transmission-side terminal device, corresponding to the confirmation request level data; and a message transmission step of transmitting the message data received in the message reception step to the reception-side terminal device in a case where a time acquired from a clock means is a time on or after the scheduled transmission time selected in the scheduled transmission time selection step.

According to a fourth example aspect of the present disclosure, a program is a program that causes a computer to function as: a confirmation request level reception means for receiving confirmation request level data, transmitted by a transmission-side terminal device, indicating a request level for confirmation of message data transmitted by the transmission-side terminal device; a confirmable time period acquisition means for acquiring from a reception-side terminal device confirmable time period data indicating a time period during which the recipient is able to confirm the message data; a scheduled transmission time selection means for selecting a scheduled transmission time for transmitting message data corresponding to the confirmation request level data to the reception-side terminal device based on the confirmation request level data and the confirmable time period data; a message reception means for receiving message data transmitted by the transmission-side terminal device and corresponding to the confirmation request level data; and a message transmission means for transmitting the message data received by the message reception means to the reception-side terminal device in a case where a time acquired by a clock means is a time on or after the scheduled transmission time selected by the scheduled transmission time selection means.

According to a fifth example aspect of the present disclosure, a program is a program for causing a computer to function as: a confirmation request level designation means for receiving a selection operation of a sender to designate a request level for confirmation of message data to be transmitted and transmitting the confirmation request level data indicating the designated request level for confirmation to a server device; a scheduled transmission time reception means for receiving from the server device and presenting to the sender data indicating the scheduled transmission time selected by the server device based on the confirmation request level data and confirmable time period data indicating the time period during which the recipient is able to confirm the message data, the server device having acquired the confirmable time period data from a reception-side terminal device; and a message transmission means for receiving an operation performed by the sender to transmit to the server device message data corresponding to the confirmation request level data.

### Effect of Invention

According to the present disclosure, even if the sender does not know the exact time when the recipient will be able to confirm the message, it is possible to send a message while avoiding times that are inconvenient for the recipient.

### BRIEF DESCRIPTION OF DRAWINGS

FIG. 1 is a block diagram showing the configuration of the message transmission/reception system according to the present disclosure.

FIG. 2 is a block diagram showing an internal configuration of the transmission-side terminal device according to the present disclosure.

FIG. 3 is a diagram showing an example of the screen displayed on the display portion of the transmission-side terminal device according to the present disclosure.

FIG. 4 is a block diagram showing the internal configuration of a reception-side terminal device according to the present disclosure.

FIG. 5 is a diagram showing an example of a screen displayed on the display portion of a reception-side terminal device according to the present disclosure.

FIG. 6 is a block diagram illustrating an example of the hardware configuration of a transmission-side terminal device and a reception-side terminal device according to the present disclosure.

FIG. 7 is a block diagram showing an internal configuration of a server device according to the present disclosure.

FIG. 8 is a diagram showing the data format of a table stored in a transmission-side data storage portion included in a server device according to the present disclosure, and changes in the data stored in the table.

FIG. 9 is a diagram showing an example of the data format of the table stored in a confirmable time period storage portion included in a server device according to the present disclosure.

FIG. 10 is a block diagram illustrating an example hardware configuration of the server device according to the present disclosure.

FIG. 11 is a diagram (part one) showing the flow of processing performed by the message transmission/reception system according to the present disclosure.

FIG. 12 is a diagram (part two) showing the flow of processing performed by the message transmission/reception system according to the present disclosure.

FIG. 13 is a flowchart showing a subroutine process of a scheduled transmission time selection process performed in the process performed by the message transmission/reception system according to the present disclosure.

FIG. 14 is a diagram showing changes in the content of a message creation area displayed on a display portion of the transmission-side terminal device according to the present disclosure.

FIG. 15 is a block diagram showing a configuration of a server device according to the present disclosure.

FIG. 16 is a flowchart showing the flow of processing performed by a server device according to the present disclosure.

### EXAMPLE EMBODIMENT

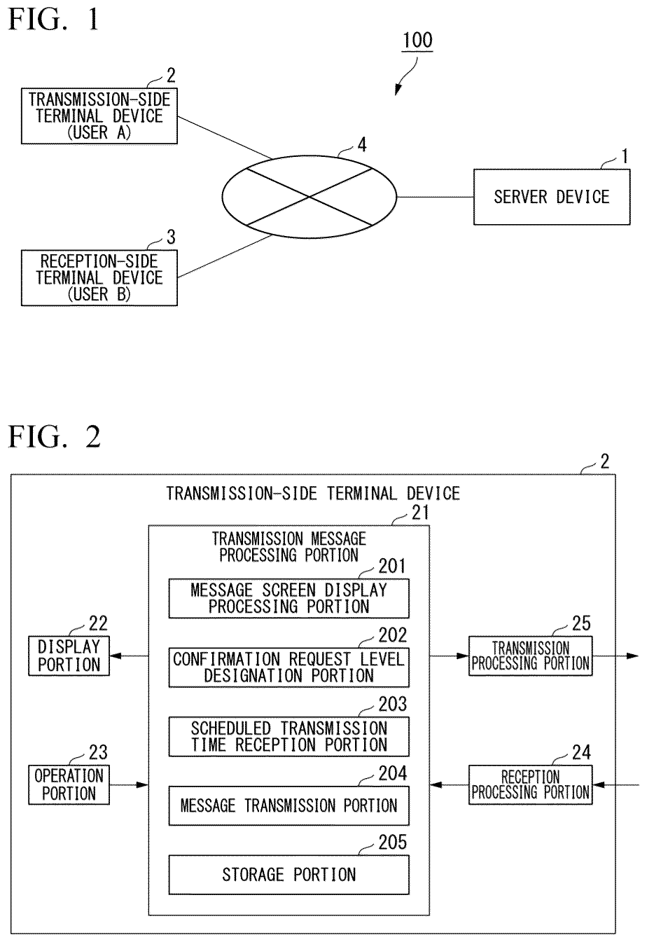

Hereinbelow, a message transmission/reception system 100 according to an example embodiment of the present disclosure will be described with reference to the drawings. FIG. 1 is a block diagram showing the configuration of a message transmission/reception system 100. The message transmission/reception system 100 includes a server device 1, a transmission-side terminal device 2, a reception-side terminal device 3, and a communication network 4. The communication network 4 interconnects the server device 1, the transmission-side terminal device 2, and the reception-side terminal device 3. The server device 1, the transmission-side terminal device 2, and the reception-side terminal device 3 may be connected to the communication network 4 via a wired line or via a wireless line. The communication network 4 is, for example, a communication network in which a plurality of access networks each connected to the server device 1, the transmission-side terminal device 2, and the reception-side terminal device 3 are interconnected with the Internet. For example, in a case where the server device 1 connects to the communication network 4 using a wireless line, the access network to which the server device 1 connects becomes the communication network of the wireless line. For example, in a case where the server device 1 is connected to the communication network 4 using a wired line, the access network to which the server device 1 is connected is the wired communication network.

FIG. 1 shows a transmission-side terminal device 2, which is a terminal device that transmits message data, and a reception-side terminal device 3, which is a terminal device that receives the message data. The reason for clearly separating the transmission side and reception side in this manner is to clearly show the difference between the configuration of the terminal device that transmits message data and the configuration of the terminal device that receives message data. In actual operation, the transmission-side terminal device 2 may have the same configuration as the reception-side terminal device 3 and so be a terminal device that transmits and receives message data, and the reception-side terminal device 3 may have the same configuration as the transmission-side terminal device 2 and so be a terminal device that transmits and receives message data. Furthermore, three or more terminal devices that transmit and receive message data in this manner may be present in the message transmission/reception system 100. In FIG. 1, the name of the user who uses the transmission-side terminal device 2 is “User A,” and the name of the user who uses the reception-side terminal device 3 is “User B.”

### Configuration of Transmission-Side Terminal Device

FIG. 2 is a block diagram showing the internal configuration of the transmission-side terminal device 2. The transmission-side terminal device 2 may be, for example, a mobile terminal device such as a smartphone, or a terminal device such as a personal computer. The transmission-side terminal device 2 includes a transmission message processing portion 21, a display portion 22, an operation portion 23, a reception processing portion 24, and a transmission processing portion 25. The display portion 22 has a screen such as a liquid crystal display, and displays data on the screen. The operation portion 23 is, for example, a touch panel, a keyboard, a mouse, or the like, and receives operations from a user A, who is a user, and outputs data corresponding to the received operations. The reception processing portion 24 is connected to the communication network 4, and outputs various signals received from the server device 1 via the communication network 4 to the transmission message processing portion 21.

The transmission processing portion 25 is connected to the communication network 4 and transmits various signals output by the transmission message processing portion 21 to the server device 1 via the communication network 4. If the communication network 4 is, for example, a communication network that transmits and receives data based on IP (Internet Protocol) addresses, the transmission processing portion 25 pre-stores in an internal storage area the IP address corresponding to the destination information included in the data transmitted by the transmission message processing portion 21. The transmission processing portion 25 stores the IP address assigned to the transmission-side terminal device 2 as its own IP address in the internal storage area. The transmission processing portion 25, upon taking in data output by the transmission message processing portion 21, detects, from the internal storage area, the IP address that corresponds to the destination information included in the taken-in data. The transmission processing portion 25 generates an IP packet with the detected IP address as the destination address and its own IP address stored in the internal storage area as the source address, and then sends out the generated IP packet along with the taken-in data to the communication network 4.

The transmission message processing portion 21 is a functional unit that corresponds to the transmission function of an instant messenger application, for example. The transmission message processing portion 21 includes a message screen display processing portion 201, a confirmation request level designation portion 202, a scheduled transmission time reception portion 203, a message transmission portion 204, and a storage portion 205. The storage portion 205 stores user identification information that is given in advance to the user A, who is the user of the transmission-side terminal device 2, as the user's own user identification information. The storage portion 205 stores user identification information corresponding to users with whom messages are exchanged. Here, the user identification information of user A, the user of the transmission-side terminal device 2, is user A's name, “user A,” and the user identification information of user B, the user of the reception-side terminal device 3, is user B's name, “user B.”

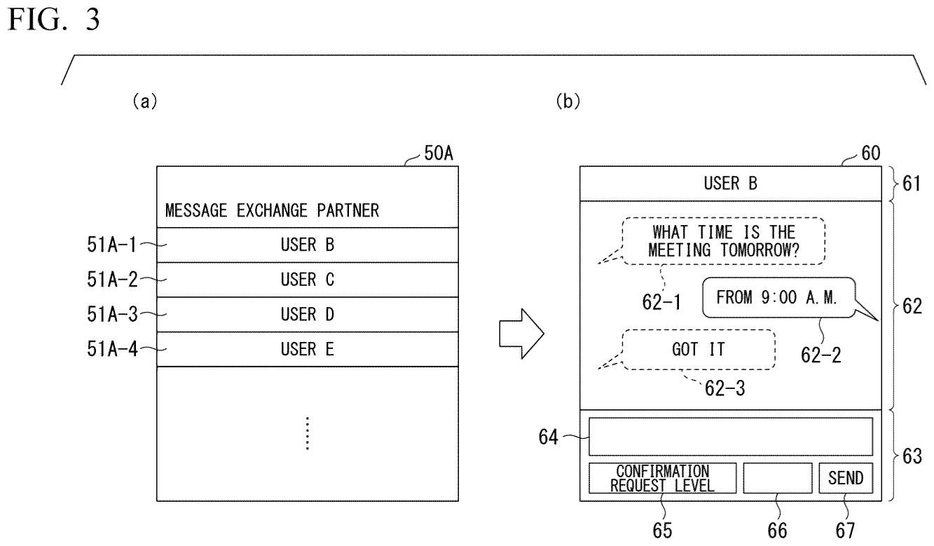

The message screen display processing portion 201, upon receiving a start-up instruction signal from the operation portion 23 that has been operated by the user A, displays in the display portion 22 an initial screen 50A shown in part (a) of FIG. 3. As shown in part (a) of FIG. 3, the initial screen 50A includes a plurality of user selection buttons 51A-1, 51A-2, 51A-3, . . . each of which displays user identification information corresponding to a user with which to exchange messages stored in the storage portion 205. For example, if the user A performs an operation to press the user selection button 51A-1 for “user B” via the operation portion 23, the operation portion 23 outputs an instruction signal indicating that the user selection button 51A-1 has been pressed to the message screen display processing portion 201. The message screen display processing portion 201, upon receiving an instruction signal from the operation portion 23 indicating that the user selection button 51A-1 has been pressed, displays a message exchange screen 60 shown in part (b) of FIG. 3.

As shown in part (b) of FIG. 3, the message exchange screen 60 includes a message exchange partner display area 61, a message exchange history display area 62, and a message creation area 63. In the message exchange partner display area 61, user identification information of a partner with whom a message is exchanged is displayed. The message exchange screen 60 shown in part (b) of FIG. 3 is a screen that is displayed in case where the user selection button 51A-1 is pressed. Therefore, the message screen display processing portion 201 displays “User B” in the message exchange partner display area 61 in part (b) of FIG. 3.

In the message exchange history display area 62, message data transmitted from the transmission-side terminal device 2 to the reception-side terminal device 3 via the server device 1, in other words, message data transmitted by user A to user B, is displayed. For example, the message data enclosed in a solid line balloon frame indicated by reference numeral 62-2 is the message data sent by the user A to the user B. Message data is stored in the storage portion 205, and when the message screen display processing portion 201 displays the message exchange screen 60 on the display portion 22, it reads out the message data stored in the storage portion 205 and displays it in the message exchange history display area 62.

As described above, in actual operation, the transmission-side terminal device 2 will have the functions that the reception-side terminal device 3 has, and the transmission-side terminal device 2 will receive message data transmitted by the reception-side terminal device 3 via the server device 1. In this case, for example, as shown in part (b) of FIG. 3, the message data transmitted by the user B to the user A is displayed in the message exchange history display area 62 as message data enclosed in dashed speech bubble frames indicated by the reference numerals 62-1 and 62-3.

The message creation area 63 includes a message input area 64, a confirmation request level selection button 65, a scheduled transmission time display area 66, and a send button 67. If the user A performs an operation to write characters, symbols, etc. in the message input area 64 via the operation portion 23, the message screen display processing portion 201 displays the written characters, symbols, etc. in the message input area 64. If characters, symbols, etc. are written in the message input area 64, the message screen display processing portion 201 treats the written characters, symbols, etc. as new message data from the user A to user B. If characters, symbols, etc. are written in the message input area 64, the message screen display processing portion 201 generates new message identification information.

The message screen display processing portion 201 associates the generated message identification information with the new message data. In addition, for each piece of message data where the combination of transmission side user identification information and reception side user identification information is identical, the message screen display processing portion 201 generates and associates different message identification information that can specify the order in which the messages were generated. Here, the message identification information that can specify the order of generation is information indicated by consecutive numbers such as “0001”, “0002”, “0003”, . . . . By associating such user identification information with message data, a single piece of message data can be identified by identifying the transmission side user identification information, the reception side user identification information, and the message identification information.

If user A operates the confirmation request level selection button 65 via the operation portion 23 to select one of the confirmation request levels, the confirmation request level designation portion 202 detects the selected confirmation request level. Here, the confirmation request level is information such as “immediately,” “in the morning,” “today,” “this week,” or “no reply required,” and indicates the degree of urgency when requesting the recipient to confirm the message data to be sent. The scheduled transmission time reception portion 203, upon receiving data indicating the scheduled transmission time from the server device 1 via the reception processing portion 24, displays the received data indicating the scheduled transmission time in the scheduled transmission time display area 66.

The message transmission portion 204, upon receiving an instruction signal indicating that the send button 67 has been pressed from the operation portion 23 that has received an operation from the user A, performs the following process. At a time when receiving the instruction signal, the message transmission portion 204 transmits the message data displayed in the message input area 64 (hereinafter, referred to as input message data) to the server device 1 via the transmission processing portion 25. The message transmission portion 204 displays the input message data in the message exchange history display area 62. The message transmission portion 204 writes and stores the input message data in the storage portion 205 in association with the user identification information of the recipient displayed in the message exchange partner display area 61 and the message identification information corresponding to the input message data.

### Configuration of Reception-Side Terminal Device

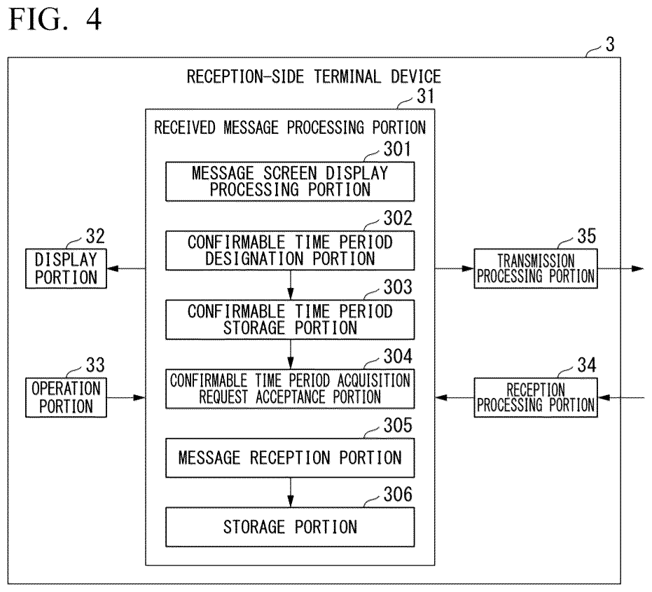

FIG. 4 is a block diagram showing the internal configuration of the reception-side terminal device 3. The reception-side terminal device 3 may be, for example, a mobile terminal device such as a smartphone, or a terminal device such as a personal computer. Both the transmission-side terminal device 2 and the reception-side terminal device 3 may be mobile terminal devices such as smartphones, or may be terminal devices such as personal computers. Furthermore, one of the transmission-side terminal device 2 and the reception-side terminal device 3 may be a mobile terminal device such as a smartphone, and the other may be a terminal device such as a personal computer.

The reception-side terminal device 3 includes a received message processing portion 31, a display portion 32, an operation portion 33, a reception processing portion 34, and a transmission processing portion 35. The display portion 32 has a screen such as a liquid crystal display, and displays data on the screen. The operation portion 33 is, for example, a touch panel, a keyboard, a mouse, or the like, and receives operations from a user B, who is a user, and outputs data corresponding to the received operations.

The reception processing portion 34 has the same configuration as the reception processing portion 24 of the transmission-side terminal device 2. The transmission processing portion 35 has the same configuration as the transmission processing portion 25 of the transmission-side terminal device 2, but the IP address assigned to the reception-side terminal device 3 is stored in the internal storage area of the transmission processing portion 35 as its own IP address.

The received message processing portion 31 is a functional unit that corresponds to the receiving function of an instant messenger application, for example. The received message processing portion 31 includes a message screen display processing portion 301, a confirmable time period designation portion 302, a confirmable time period storage portion 303, a confirmable time period acquisition request acceptance portion 304, a message reception portion 305, and a storage portion 306. The storage portion 306 stores “user B”, which is user identification information assigned in advance to user B, who is the user of the reception-side terminal device 3, as its own user identification information. The storage portion 306 stores user identification information corresponding to users with whom messages are exchanged.

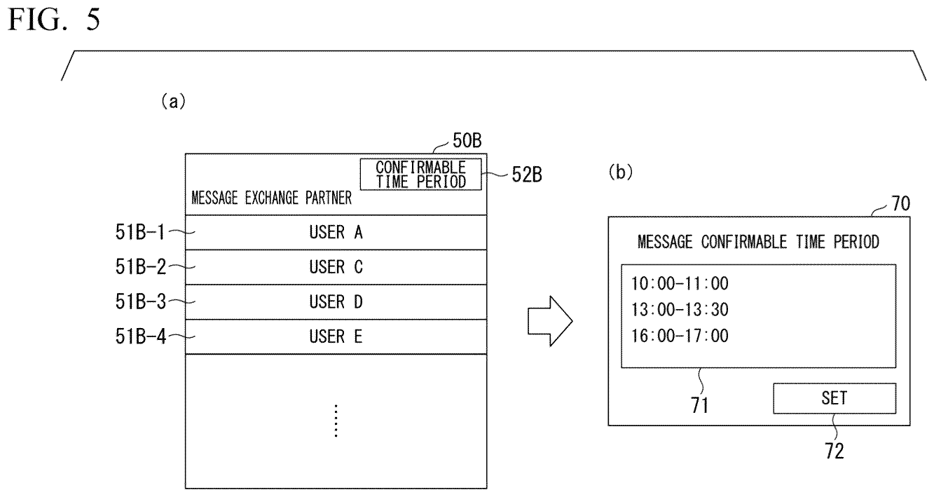

The message screen display processing portion 301, upon receiving a start-up instruction signal from the operation portion 33 that has been operated by the user B, displays an initial screen 50B shown in part (a) of FIG. 5 in the display portion 32. As shown in part (a) of FIG. 5, the initial screen 50B includes a plurality of user selection buttons 51B-1, 51B-2, 51B-3, . . . each respectively displaying user identification information corresponding to the user with which messages stored in the storage portion 306 will be exchanged, and a confirmable time period setting button 52B. For example, if user B performs an operation to press user selection button 51B-1 for “user A” via operation portion 33, the operation portion 33 outputs an instruction signal indicating that user selection button 51B-1 has been pressed to the message screen display processing portion 301. The message screen display processing portion 301, upon receiving an instruction signal from the operation portion 33 that the user selection button 51B-1 has been pressed, displays on the display portion 32 a screen that includes at least an area similar to the message exchange partner display area 61 and the message exchange history display area 62 of the message exchange screen 60 shown in part (b) of FIG. 3. The message screen display processing portion 301 displays the message data from user A in an area corresponding to the message exchange history display area 62 on the displayed screen. This allows the user B to check the contents of the message sent from user A.

The confirmable time period designation portion 302, upon receiving an instruction signal from the operation portion 33 that has received an operation from user B indicating that the confirmable time period setting button 52B on the initial screen 50B has been pressed, displays the confirmable time period setting screen 70 shown in part (b) of FIG. 5 on the display portion 32. As shown in part (b) of FIG. 5, the confirmable time period setting screen 70 includes the confirmable time period input area 71 and a setting button 72. If the user B performs an operation via the operation portion 33 to write a start time and an end time indicating the time period when the message can be confirmed, such as “10:00-11:00”, in the confirmable time period input area 71, the confirmable time period designation portion 302 displays the written time in the confirmable time period input area 71. The user B can operate the operation portion 33 to input multiple time periods as confirmable time periods in the confirmable time period input area 71, such as “10:00-11:00”, “13:00-13:30”, and “16:00-17:00” shown in part (b) of FIG. 5. Furthermore, the start time and end time are not limited to times specified by hours and minutes, but may be times obtained by adding the year, month, and day, or the month and day, or the day to the hours and minutes.

Defined in more detail, in this example embodiment, the meaning of the term “time” is to indicate either a time expressed by the year, month, day, hour, and minute, such as “December 31, 2022, 23:59,” a time expressed by the month, day, hour, and minute, such as “December 31, 23:59,” a time expressed by the day, hour, and minute, such as “31st, 23:59,” or a time expressed by the hour and minute, such as “23:59”. If the “year” is not specified, it is interpreted as a time without any year restrictions, if the “month” is not specified, it is interpreted as a time without any month restrictions, and if the “day” is not specified, it is interpreted as a time without any day restrictions. Additionally, the term “time period” is intended to indicate the length of time between two times.

The confirmable time period designation portion 302, upon receiving an instruction signal from the operation portion 33 that has received an operation from the user B indicating that the setting button 72 on the confirmable time period setting screen 70 has been pressed, imports the time period written on the confirmable time period setting screen 70 at the time of receiving the instruction signal as data indicating the confirmable time period (hereinafter referred to as confirmable time period data). The confirmable time period storage portion 303 stores the confirmable time period data taken in by the confirmable time period designation portion 302. The confirmable time period acquisition request acceptance portion 304, upon receiving a confirmable time period acquisition request signal from the server device 1 via the reception processing portion 34, reads out the confirmable time period data stored in the confirmable time period storage portion 303. The confirmable time period acquisition request acceptance portion 304 transmits the read confirmable time period data to the server device 1 via the transmission processing portion 35. The message reception portion 305, upon receiving message data from the server device 1 via the reception processing portion 34, writes the received message data in the storage portion 306.

### Hardware Configuration of Transmission-Side Terminal Device and Reception-Side Terminal Device

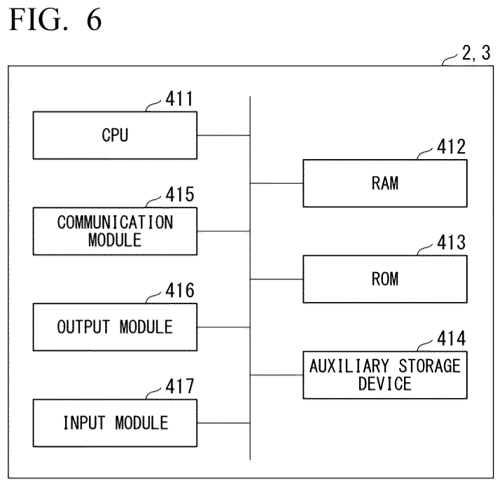

FIG. 6 is a diagram showing an example of the hardware configuration of the transmission-side terminal device 2 and the reception-side terminal device 3. The transmission-side terminal device 2 and the reception-side terminal device 3 are computers each including, for example, a CPU (central processing portion) 411, a RAM (Random Access Memory) 412, a ROM (Read Only Memory) 413, an auxiliary storage device 414, a communication module 415, an output module 416, and an input module 417. The components of the transmission-side terminal device 2 and the reception-side terminal device 3, namely the CPU 411, RAM 412, ROM 413, auxiliary storage device 414, communication module 415, output module 416, and input module 417, are indicated with the same reference numerals, but the transmission-side terminal device 2 and the reception-side terminal device 3 may include the same types of components or different types of components. The CPU 411, the RAM 412, the ROM 413, the auxiliary storage device 414, the communication module 415, the output module 416, and the input module 417 are connected to each other via a bus. Here, the auxiliary storage device 414 is, for example, a hard disk drive (HDD) or a solid state drive (SDD). The communication module 415 corresponds to the reception processing portions 24 and 34 and the transmission processing portions 25 and 35. The output module 416 corresponds to the display portions 22 and 32, and the input module 417 corresponds to the operation portions 23 and 33. In addition, if the transmission-side terminal device 2 and the reception-side terminal device 3 are, for example, personal computers, an output interface may be provided instead of the output module 416, and an external display device such as an LCD display may be connected to the output interface. Moreover, an input interface may be provided instead of the input module 417, and an input device such as a keyboard or a mouse may be connected to the input interface.

In the case of the transmission-side terminal device 2, an application program pre-stored in the ROM 413 or the auxiliary storage device 414 is executed by the CPU 411, whereby the functional parts of the message screen display processing portion 201, the confirmation request level designation portion 202, the scheduled transmission time reception portion 203, and the message transmission portion 204 of the transmission message processing portion 21 are configured, and a storage area corresponding to the storage portion 205 is allocated in the RAM 412 or the auxiliary storage device 414.

In the case of the reception-side terminal device 3, an application program pre-stored in the ROM 413 or the auxiliary storage device 414 is executed by the CPU 411, whereby the functional parts of the received message processing portion 31, the message screen display processing portion 301, the confirmable time period designation portion 302, the confirmable time period acquisition request acceptance portion 304, and the message reception portion 305 are configured, and memory areas corresponding to the confirmable time period storage portion 303 and the storage portion 306 are allocated in the RAM 412 or the auxiliary storage device 414.

### Configuration of Server Device

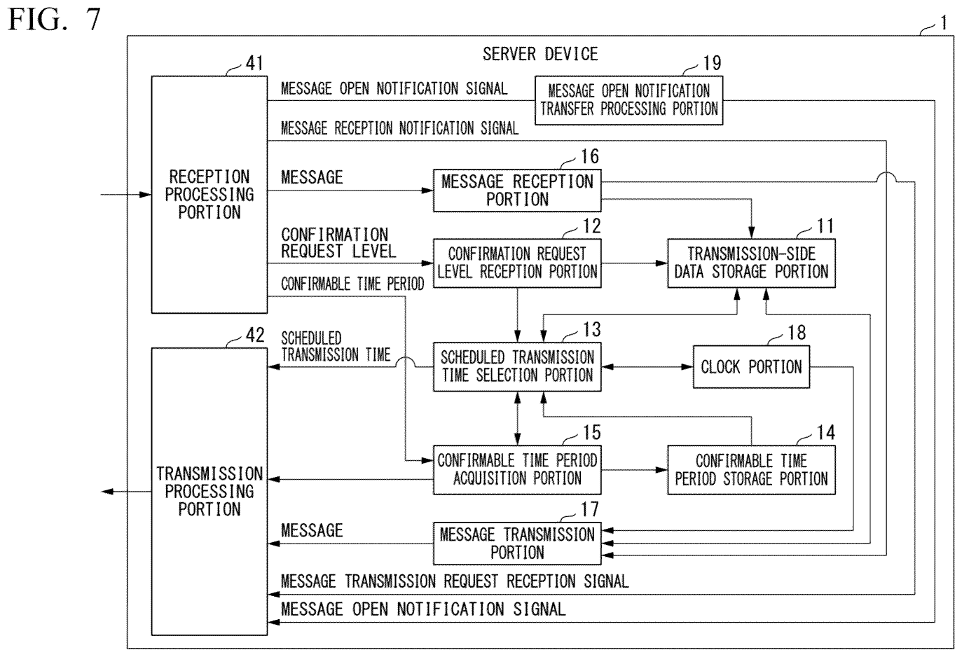

FIG. 7 is a block diagram showing the internal configuration of the server device 1. The server device 1 includes a transmission-side data storage portion 11, a confirmation request level reception portion 12, a scheduled transmission time selection portion 13, a confirmable time period storage portion 14, a confirmable time period acquisition portion 15, a message reception portion 16, a message transmission portion 17, a clock portion 18, a message open notification transfer processing portion 19, a reception processing portion 41, and a transmission processing portion 42.

The clock portion 18 is, for example, a clock that is adjusted to show accurate time, and upon receiving a time acquisition request signal, it outputs time data indicating the date, day of the week, hour, and minute of the time when the time acquisition request signal was received to the functional portion that outputs the time acquisition request signal. The reception processing portion 41 has the same configuration as the reception processing portion 24 of the transmission-side terminal device 2 and the reception processing portion 34 of the reception-side terminal device 3. The transmission processing portion 42 has the same configuration as the transmission processing portion 25 of the transmission-side terminal device 2 and the transmission processing portion 35 of the reception-side terminal device 3, but the IP address assigned to the server device 1 is stored in the internal storage area of the transmission processing portion 42 as its own IP address.

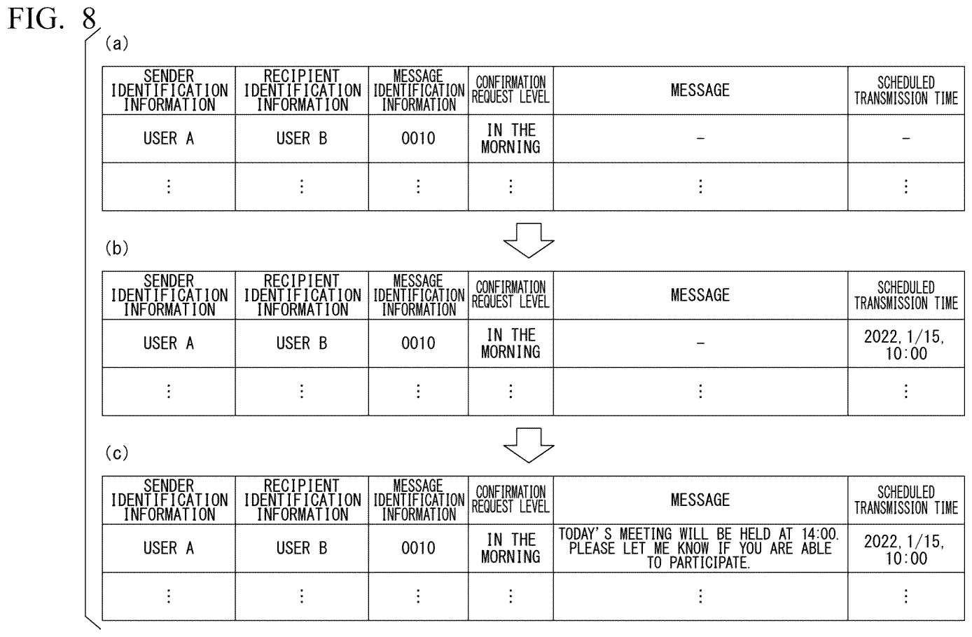

The transmission-side data storage portion 11 stores, for example, a table in the data format shown in part (a) of FIG. 8. The table stored in the transmission-side data storage portion 11 has the following items, as shown in part (a) of FIG. 8:“sender identification information,” “recipient identification information,” “message identification information,” “confirmation request level,” “message,” and “scheduled transmission time”. In the “sender identification information” field, the user identification information of the sender of the message data is written. In the “recipient identification information” field, the user identification information of the recipient of the message data is written. In the “message identification information” field, message identification information generated for the message data is written. In the “confirmation request level” field, confirmation request level data received by the confirmation request level reception portion 12 is written. In the “message” field, message data received by the message reception portion 16 is written. In the “scheduled transmission time” field, data indicating the scheduled transmission time selected by the scheduled transmission time selection portion 13 is written.

The confirmation request level reception portion 12 receives a scheduled transmission time request signal from the transmission-side terminal device 2 via the reception processing portion 41. The confirmation request level reception portion 12, upon receiving the scheduled transmission time request signal, generates a new record in the table of the transmission-side data storage portion 11. The confirmation request level reception portion 12 writes the sender identification information, the recipient identification information, the message identification information, and the confirmation request level data contained in the scheduled transmission time request signal into the generated record. The confirmation request level reception portion 12 outputs a selective disclosure instruction signal including the sender identification information, the recipient identification information, and the message identification information contained in the scheduled transmission time request signal to the scheduled transmission time selection portion 13.

The message reception portion 16 receives a message transmission request signal from the transmission-side terminal device 2 via the reception processing portion 41. The message reception portion 16 detects one record stored in the table of the transmission-side data storage portion 11 based on the sender identification information, recipient identification information, and message identification information contained in the received message transmission request signal. The message reception portion 16 writes the message data contained in the received message transmission request signal into the “message” field of the detected record.

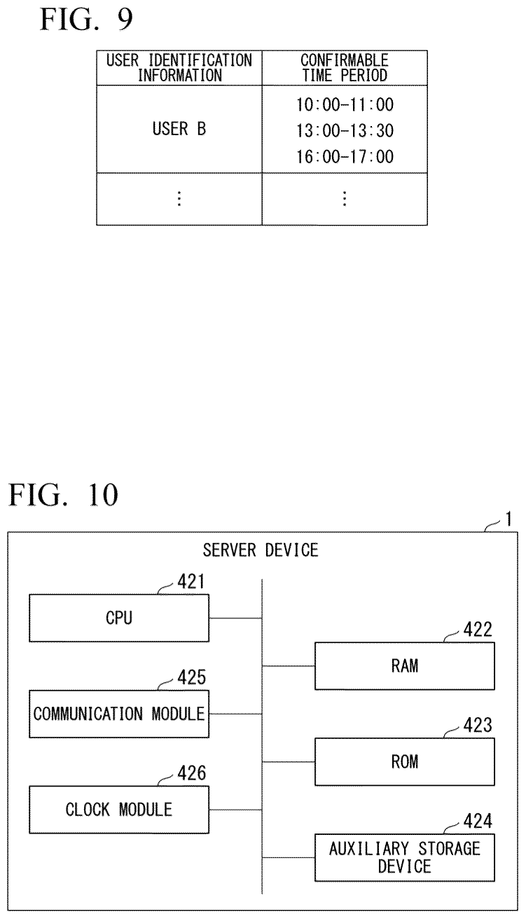

The confirmable time period storage portion 14 stores, for example, a table in the data format shown in FIG. 9. The table stored by the confirmable time period storage portion 14 has the items “user identification information” and “confirmable time period” as shown in FIG. 9. In the “user identification information” field, user identification information is written. In the “confirmable time period” field, confirmable time period data is written.

The confirmable time period acquisition portion 15 transmits a confirmable time period acquisition request signal to the reception-side terminal device 3 via the transmission processing portion 42, and receives a confirmable time period acquisition response signal from the reception-side terminal device 3 via the reception processing portion 41. The confirmable time period acquisition portion 15 writes the user identification information and the confirmable time period data contained in the received confirmable time period acquisition response signal into the table of the confirmable time period storage portion 14.

The scheduled transmission time selection portion 13, upon receiving a selective disclosure instruction signal from the confirmation request level reception portion 12, detects the record corresponding to the sender identification information, recipient identification information, and message identification information contained in the received selective disclosure instruction signal from the table in the transmission-side data storage portion 11. The scheduled transmission time selection portion 13 reads out the confirmation request level data written in the “confirmation request level” field of the detected record. The scheduled transmission time selection portion 13 detects, from the table in the confirmable time period storage portion 14, confirmable time period data corresponding to the user identification information included as recipient identification information in the selective disclosure instruction signal. The scheduled transmission time selection portion 13 selects a scheduled transmission time for transmitting message data corresponding to the confirmation request level data to the reception-side terminal device 3 corresponding to the recipient identification information, based on the read confirmation request level data and the detected confirmable time period data. The scheduled transmission time selection portion 13 writes data indicating the selected scheduled transmission time into the “scheduled transmission time” field of the record detected from the table in the transmission-side data storage portion 11.

The message transmission portion 17 obtains time data from the clock portion 18 at regular intervals. Every time the message transmission portion 17 obtains time data from the clock portion 18, it refers to the scheduled transmission time written in the “scheduled transmission time” field of each record in the table in the transmission-side data storage portion 11. The message transmission portion 17 detects from the table of the transmission-side data storage portion 11 a record in which the referenced scheduled transmission time is on or after the time indicated by the time data obtained from the clock portion 18. The message transmission portion 17 generates a message transmission signal based on the detected record, and outputs the generated message transmission signal to the transmission processing portion 42.

The message open notification transfer processing portion 19 receives the message open notification signal via the reception processing portion 41. The message open notification transfer processing portion 19 transfers, via the transmission processing portion 42, the received message open notification signal, with the user identification information indicated as recipient identification information in the received message opening notification signal serving as the transmission destination.

### Hardware Configuration of Server Device

FIG. 10 is a diagram illustrating an example of the hardware configuration of the server device 1. The server device 1 is a computer including, for example, a CPU 421, a RAM 422, a ROM 423, an auxiliary storage device 424, a communication module 425, and a clock module 426. The CPU 421, the RAM 422, the ROM 423, the auxiliary storage device 424, the communication module 425, and the clock module 426 are connected to each other via a bus. Here, the auxiliary storage device 424 is, for example, a hard disk drive (HDD) or a solid state drive (SDD). The communication module 425 corresponds to the reception processing portion 41 and the transmission processing portion 42. The clock module 426 corresponds to the clock portion 18. If an application program pre-stored in the ROM 423 or the auxiliary storage device 424 is executed by the CPU 421, functional portions including the confirmation request level reception portion 12, the scheduled transmission time selection portion 13, the confirmable time period acquisition portion 15, the message reception portion 16, the message transmission portion 17, and a message open notification transfer processing portion 19 are configured, and memory areas corresponding to the transmission-side data storage portion 11 and the confirmable time period storage portion 14 are allocated in the RAM 422 or the auxiliary storage device 424.

### Processing Performed by Message Transmission/Reception System

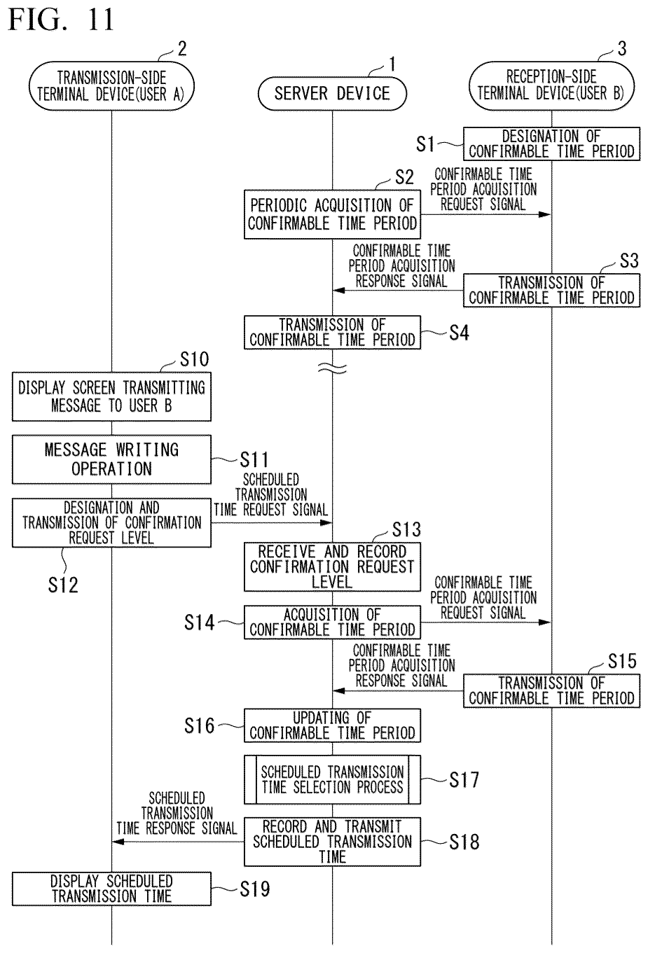

The process performed by the message transmission/reception system 100 will be described with reference to FIGS. 11 to 13. A user B, who is the user of the reception-side terminal device 3, performs an operation to output the start-up instruction signal to the message screen display processing portion 301 via the operation portion 33 of the reception-side terminal device 3. The message screen display processing portion 301, upon receiving the start-up instruction signal from the operation portion 33, displays the initial screen 50B shown in part (a) of FIG. 5 in the display portion 32. The user B performs an operation of pressing the confirmable time period setting button 52B on the initial screen 50B via the operation portion 33. The confirmable time period designation portion 302, upon receiving an instruction signal from the operation portion 33 indicating that the confirmable time period setting button 52B has been pressed, displays on the display portion 32 the confirmable time period setting screen 70 shown in part (b) of FIG. 5. The user B performs an operation via the operation portion 33 to write the confirmable time period in the confirmable time period input area 71. Here, as shown in part (b) of FIG. 5, it is assumed that the user B has performed an operation to write “10:00-11:00”, “13:00-13:30”, and “16:00-17:00” in the confirmable time period input area 71.

The user B performs an operation of pressing the setting button 72 on the confirmable time period setting screen 70 via the operation portion 33. The confirmable time period designation portion 302, upon receiving an instruction signal from the operation portion 33 indicating that the setting button 72 on the confirmable time period setting screen 70 has been pressed, takes in the time period written on the confirmable time period setting screen 70 at the time of receiving the instruction signal as confirmable time period data. The confirmable time period designation portion 302, upon taking in the confirmable time period data, erases the confirmable time period setting screen 70 from the display portion 32. The confirmable time period designation portion 302 writes and stores the taken-in confirmable time period data in the confirmable time period storage portion 303. If previous confirmable time period data has been written in the confirmable time period storage portion 303, the confirmation time designation portion 302 rewrites the previous confirmable time period data with the taken-in confirmable time period data (Step S1).

The confirmable time period acquisition portion 15 of the server device 1 generates a confirmable time period acquisition request signal with the destination user identification information as “User B,” and transmits the generated confirmable time period acquisition request signal to the reception-side terminal device 3 via the transmission processing portion 42 (Step S2). The confirmable time period acquisition request acceptance portion 304 of the reception-side terminal device 3, upon receiving the confirmable time period acquisition request signal from the server device 1 via the reception processing portion 34, reads out the confirmable time period data from the confirmable time period storage portion 303. The confirmable time period acquisition request acceptance portion 304 generates a confirmable time period acquisition response signal that includes the read-out confirmable time period data and the user identification information of “User B” stored in the storage portion 306 as its own user identification information, with the server device 1 as the transmission destination. The confirmable time period acquisition request acceptance portion 304 transmits the generated confirmable time period acquisition response signal to the server device 1 via the transmission processing portion 35 (Step S3).

The confirmable time period acquisition portion 15 of the server device 1 receives the confirmable time period acquisition response signal from the reception-side terminal device 3 via the reception processing portion 41. The confirmable time period acquisition portion 15 determines whether or not a record corresponding to “user B”, which is the user identification information included in the received confirmable time period acquisition response signal, exists in the table of the confirmable time period storage portion 14. If the confirmable time period acquisition portion 15 determines that a record corresponding to “user B” does not exist, it creates a new record. The confirmable time period acquisition portion 15 writes each of the user identification information and confirmable time period data contained in the received confirmable time period acquisition response signal into the corresponding fields of the generated record. On the other hand, if the confirmable time period acquisition portion 15 determines that a record corresponding to “User B” exists, it rewrites the previous confirmable time period data written in the “confirmable time” field of that record to the confirmable time period data included in the received confirmable time period acquisition response signal (Step S4). The confirmable time period acquisition portion 15 performs the process of Step S2 at a predetermined fixed interval. As a result, the confirmable time period data in the table of the confirmable time period storage portion 14 is updated periodically.

The user A, who is the user of the transmission-side terminal device 2, performs an operation to output the start-up instruction signal to the message screen display processing portion 201 via the operation portion 23 of the transmission-side terminal device 2. The message screen display processing portion 201, upon receiving the start-up instruction signal from the operation portion 23, displays the initial screen 50A shown in part (a) of FIG. 3 in the display portion 22. If the user A performs an operation to press the user selection button 51A-1 for “user B” via the operation portion 23, the operation portion 23 outputs an instruction signal indicating that the user selection button 51A-1 has been pressed to the message screen display processing portion 201. The message screen display processing portion 201, upon receiving an instruction signal from the operation portion 23 indicating that the user selection button 51A-1 has been pressed, displays a message exchange screen 60 shown in part (b) of FIG. 3 (Step S10).

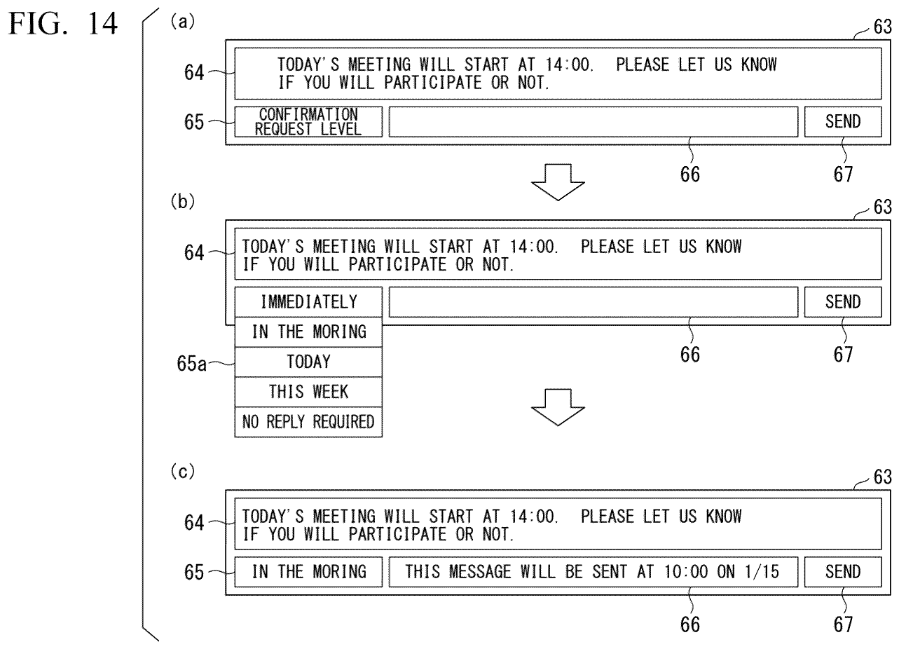

FIG. 14 is a diagram showing the message creation area 63 of the message exchange screen 60. If the user A performs an operation to write characters, symbols, etc. in the message input area 64 via the operation portion 23, as shown in part (a) of FIG. 14, the message screen display processing portion 201 displays the written characters, symbols, etc. in the message input area 64. Part (a) of FIG. 14 shows an example of the following text string being written: “Today's meeting will start at 14:00. Please let us know if you will participate or not.” If characters, symbols, etc. are written in the message input area 64, the message screen display processing portion 201 generates new message identification information and associates it with the message data written in the message input area 64. Here, it is assumed that the message screen display processing portion 201 generates “0010” as the message identification information (Step S11).

If the user A performs the action of pressing the confirmation request level selection button 65 in the message creation area 63 via the operation portion 23, the message screen display processing portion 201 displays a pull-down menu 65a displaying each of a number of confirmation request levels in place of the confirmation request level selection button 65, as shown in part (b) of FIG. 14. The user A performs an operation via the operation portion 23 to select one of the confirmation request levels shown in the pull-down menu 65a. Here, it is assumed that the user A has selected “in the morning” as the confirmation request level. The message screen display processing portion 201, upon receiving an instruction signal indicating that “in the morning” has been selected as the confirmation request level from the operation portion 23, erases the pull-down menu 65a. The message screen display processing portion 201 displays a character string indicating the selected confirmation request level, that is, “in the morning”, at the position of the confirmation request level selection button 65, as shown in part (c) of FIG. 14.

If one of the confirmation request levels shown in the pull-down menu 65a is selected, the confirmation request level designation portion 202 detects and obtains the selected confirmation request level, i.e., the confirmation request level displayed at the position of the confirmation request level selection button 65. In the example shown in part (c) of FIG. 14, the confirmation request level designation portion 202 detects and acquires the confirmation request level data of “in the morning.”

The confirmation request level designation portion 202 acquires the user identification information of “user B” displayed in the message exchange partner display area 61 of the message exchange screen 60 as the recipient identification information. The confirmation request level designation portion 202 acquires “user A” stored in the storage portion 205 as its own user identification information as the sender identification information. The confirmation request level designation portion 202 acquires the message identification information “0010” associated with the message data displayed in the message input area 64 from the message screen display processing portion 201. The confirmation request level designation portion 202 generates a scheduled transmission time request signal that includes the acquired confirmation request level data of “in the morning,” the sender identification information of “user A,” the recipient identification information of “user B,” and the message identification information of “0010,” with the server device 1 as the transmission destination. The confirmation request level designation portion 202 transmits the generated scheduled transmission time request signal to the server device 1 via the transmission processing portion 25 (Step S12).

The confirmation request level reception portion 12 of the server device 1 receives the scheduled transmission time request signal from the transmission-side terminal device 2 via the reception processing portion 41. The confirmation request level reception portion 12, upon receiving the scheduled transmission time request signal, generates a new record in the table of the transmission-side data storage portion 11. The confirmation request level reception portion 12 writes each of the sender identification information of “user A”, the recipient identification information of “user B”, the message identification information of “0010”, and the confirmation request level data of “in the morning” contained in the scheduled transmission time request signal into the corresponding items of the generated record, as shown in part (a) of FIG. 8 (Step S13).

The confirmation request level reception portion 12 outputs a selective disclosure instruction signal including the sender identification information, the recipient identification information, and the message identification information contained in the scheduled transmission time request signal to the scheduled transmission time selection portion 13. The scheduled transmission time selection portion 13 receives the selective disclosure instruction signal outputted by the confirmation request level reception portion 12. The scheduled transmission time selection portion 13 outputs to the confirmable time period acquisition portion 15 a confirmable time period acquisition instruction signal including the recipient identification information of “user B” contained in the acquired selection disclosure instruction signal. Upon receiving the confirmable time period acquisition instruction signal from the scheduled transmission time selection portion 13, the confirmable time period acquisition portion 15 reads out the recipient identification information of “user B” contained in the received confirmable time period acquisition instruction signal. The confirmable time period acquisition portion 15 generates a confirmable time period acquisition request signal with the user identification information of “user B” that was read out as the transmission destination, and transmits the generated confirmable time period acquisition request signal to the reception-side terminal device 3 via the transmission processing portion 42 (Step S14).

Thereafter, the reception-side terminal device 3 executes the same process as Step S3 as the process of Step S15. After the process of Step S15, the confirmable time period acquisition portion 15 of the server device 1 performs the same processing as Step S4, and after writing to the table of the confirmable time period storage portion 14 is completed, it outputs a confirmable time period acquisition completion signal to the scheduled transmission time selection portion 13 (Step S16). If the reception-side terminal device 3 is, for example, offline, since the processing of Step S15 will not be executed, the confirmable time period acquisition portion 15 of the server device 1 will not be able to receive the confirmable time period acquisition response signal from the reception-side terminal device 3. Therefore, if the confirmable time period acquisition portion 15 does not receive the confirmable time period acquisition request signal even after a predetermined period of time has elapsed since sending the confirmable time period acquisition request signal, it outputs the confirmable time period acquisition completion signal to the scheduled transmission time selection portion 13. In this case, the confirmable time period data of “user B” stored in the table of the confirmable time period storage portion 14 will not be updated.

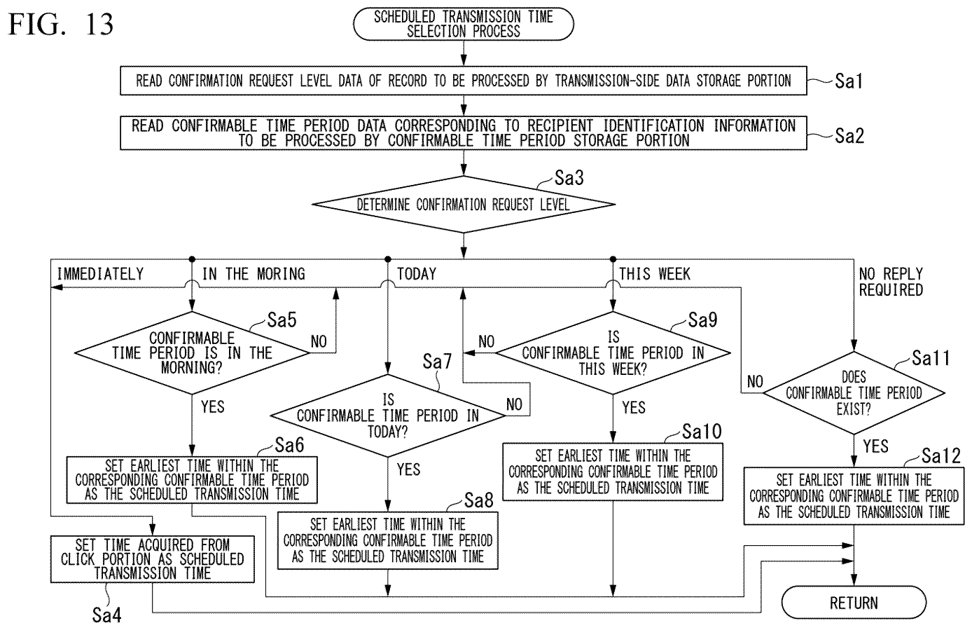

The scheduled transmission time selection portion 13, upon receiving the confirmable time period acquisition completion signal from the confirmable time period acquisition portion 15, starts the processing of the scheduled transmission time selection process subroutine shown in FIG. 13 (Step S17). The scheduled transmission time selection portion 13 detects from the table of the transmission-side data storage portion 11 the record corresponding to the combination of the sender identification information of “user A”, the recipient identification information of “user B”, and the message identification information of “0010”, contained in the selective disclosure instruction signal acquired in the processing of Step S14. The scheduled transmission time selection portion 13 reads out the confirmation request level data written in the “confirmation request level” field of the detected record (Step Sa1). The scheduled transmission time selection portion 13 detects, from the table of the confirmable time period storage portion 14, the record corresponding to the recipient identification information of “user B” contained in the acquired selective disclosure instruction signal. The scheduled transmission time selection portion 13 reads out the confirmable time period data written in the “confirmable time” field of the detected record (Step Sa2).

The scheduled transmission time selection portion 13 determines whether the confirmation request level indicated by the confirmation request level data read in the processing of Step Sa1 is “immediately,” “in the morning,” “today,” “this week,” or “no reply required” (Step Sa3). It is assumed that the scheduled transmission time selection portion 13 determines that the confirmation request level is “immediately” (Step Sa3, immediately). “Immediately” means immediate confirmation, in other words, that you want the message confirmed as soon as possible. Therefore, the scheduled transmission time selection portion 13 outputs a time acquisition request signal to the clock portion 18 and acquires time data from the clock portion 18. The scheduled transmission time selection portion 13 sets the time indicated by the time data obtained from the clock portion 18, i.e., the time specified by the year, month, day, hour, and minute, as the scheduled transmission time (Step Sa4), and terminates the processing of the subroutine.

If the scheduled transmission time selection portion 13 determines that the confirmation request level is “in the morning” (Step Sa3, in the morning), it determines whether a time period in the morning, i.e. a time period between 0:00 and 12:00, exists among the confirmable times indicated by the confirmable time period data read out in Step Sa2 (Step Sa5).

The scheduled transmission time selection portion 13, upon determining that a time period in the morning exists among the confirmable time periods (Step Sa5: Yes), sets the earliest time within the corresponding confirmable time periods as the scheduled transmission time (Step Sa6) and terminates the processing of the subroutine. On the other hand, if the scheduled transmission time selection portion 13 determines that a time period in the morning does not exist among the confirmable time periods (Step Sa5: No), the process proceeds to Step Sa4.

The scheduled transmission time selection portion 13, upon determining that the confirmation request level is “today” (Step Sa3, today), determines whether or not a time period in today, i.e. a time period between 0:00 and 24:00, exists among the confirmable time periods indicated by the confirmable time period data read out in Step Sa2 (Step Sa7).

The scheduled transmission time selection portion 13, upon determining that a time period in today exists among the confirmable time periods (Step Sa7: Yes), sets the earliest time within the corresponding confirmable time periods as the scheduled transmission time (Step Sa8) and terminates the processing of the subroutine. On the other hand, if the scheduled transmission time selection portion 13 determines that a time period in today does not exist among the confirmable time periods (Step Sa7: No), the process proceeds to Step Sa4.

In addition, in the determination processing of steps Sa5 and Sa7, if the confirmable time period indicated by the confirmable time period data is specified as a year, month, and day, or a month and day, or a day, the scheduled transmission time selection portion 13 outputs a time acquisition request signal to the clock portion 18 to acquire the time data from the clock portion 18. In the determination process of Step Sa5, the scheduled transmission time selection portion 13 determines whether the confirmable time periods include a time period between 0:00 and 12:00 on the same day as the date indicated by the acquired time data. In the determination process of Step Sa7, the scheduled transmission time selection portion 13 determines whether the confirmable times include a time between 0:00 and 24:00 on the same day as the date indicated by the acquired time data. In addition, in the determination process of steps Sa5 and Sa7, if the confirmable time period does not indicate a year but indicates a month and day, the scheduled transmission time selection portion 13 will consider it to be the same day if the month and day indicated in the acquired time data match. In the determination process of steps Sa5 and Sa7, if the confirmable time period does not indicate the year and month but indicates the day, the scheduled transmission time selection portion 13 will consider it to be the same day if the day indicated in the acquired time data matches.

If the scheduled transmission time selection portion 13 determines that the confirmation request level is “this week” (Step Sa3, this week), the scheduled transmission time selection portion 13 outputs a time acquisition request signal to the clock portion 18 and acquires time data from the clock portion 18. The scheduled transmission time selection portion 13 reads out information about the day of the week indicated in the acquired time data, and identifies the remaining dates of the week, including the current day. The scheduled transmission time selection portion 13 determines whether the confirmable time periods indicated by the confirmable time period data read in Step Sa2 include any time periods during this week, i.e., between 0:00 and 24:00 on each day of the same week (Step Sa9). In the determination process of Step Sa9, the scheduled transmission time selection portion 13 performs the following process depending on the state of the date designation in the confirmable time period. In other words, if the year is not specified for the confirmable time period but the month and day are specified, the scheduled transmission time selection portion 13 determines that the year of the confirmable time period is the same as the year indicated by the acquired time data. If the year and month are not specified for the confirmable time period but a day is specified, the scheduled transmission time selection portion 13 determines that the year and month of the confirmable time period is the same as the year and month indicated by the acquired time data. If no date is specified for the confirmable time, the scheduled transmission time selection portion 13 determines that the date of the confirmable time period is the same as the date indicated by the acquired time data.

The scheduled transmission time selection portion 13, upon determining that a time within this week exists among the confirmable time periods (Step Sa9: Yes), sets the information indicating the earliest time among the confirmable time periods as the scheduled transmission time (Step Sa10), and terminates the processing of the subroutine. On the other hand, if the scheduled transmission time selection portion 13 determines that a time period within this week does not exist among the confirmable time periods (Step Sa9: No), the process proceeds to Step Sa4.

If the scheduled transmission time selection portion 13 determines that the confirmation request level is “no reply required” (Step Sa3, no reply required), it determines whether or not a confirmable time period exists (Step Sa11). That is, the scheduled transmission time selection portion 13 determines whether or not the confirmable time period data has been read in the process of Step Sa2. It is assumed that the scheduled transmission time selection portion 13 has determined in the process of Step Sa2 that the confirmable time period data has been read out (Step Sa11: Yes). In this case, the scheduled transmission time selection portion 13 sets the earliest time among the confirmable time periods indicated by the confirmable time period data that has been read out as the scheduled transmission time (Step Sa12), and terminates the processing of the subroutine. On the other hand, if the scheduled transmission time selection portion 13 determines that the confirmable time period data could not be read among the confirmable time periods in the processing of Step Sa2 (Step Sa9: No), the processing proceeds to Step Sa4.

Here, the confirmation request level indicated by the confirmation request level data read by the scheduled transmission time selection portion 13 in the processing of Step Sa1 is “in the morning,” and the confirmable time period indicated by the confirmable time period data read by the scheduled transmission time selection portion 13 in the processing of Step Sa2 is “10:00-11:00,” “13:00-13:30,” or “16:00-17:00,” with no date specified. Accordingly, the scheduled transmission time selection portion 13 determines in the process of Step Sa3 that the confirmation request level is “in the morning”, and determines in the process of Step Sa5 that a time period in the morning exists in the confirmable time periods. In the subsequent process of Step Sa6, the scheduled transmission time selection portion 13 sets the earliest time, “10:00”, as the scheduled transmission time.

If the subroutine processing of the scheduled transmission time selection processing of FIG. 13 is completed, the process returns to the processing of FIG. 11. Incidentally, in the processing of steps Sa6, Sa8, Sa10, and Sa12 other than the processing of Step Sa4, the data indicating the scheduled transmission time may not include information indicating the date. In this case, the scheduled transmission time selection portion 13 outputs a time acquisition request signal to the clock portion 18 to acquire time data from the clock portion 18, and then adds the missing portion of the date indicated in the acquired time data in the data indicating the scheduled transmission time to the data indicating the scheduled transmission time. Note that, in the processing of steps Sa5, Sa7, and Sa9, if the scheduled transmission time selection portion 13 has acquired time data from the clock portion 18, it may reuse the already acquired time data rather than acquiring new time data.

For example, if the data indicating the scheduled transmission time is “10:00” and the acquired time data is “January 15, 2022, Saturday, 6:10,” the scheduled transmission time selection portion 13 adds the part “January 15, 2022” to set the data indicating the scheduled transmission time to “January 15, 2022, 10:00”. For example, if the data indicating the scheduled transmission time is “15th, 10:00”, the scheduled transmission time selection portion 13 adds the part “January 2022” to make the data indicating the scheduled transmission time “January 15, 2022, 10:00”. For example, if the data indicating the scheduled transmission time is “January 15th, 10:00”, the scheduled transmission time selection portion 13 adds the “2022” portion to make the data indicating the scheduled transmission time “January 15, 2022, 10:00”. Here, the following explanation will be given assuming that the scheduled transmission time selection portion 13 adds “January 15, 2022” to “10:00” to obtain “January 15, 2022, 10:00” as data indicating the scheduled transmission time.

Based on the data indicating the scheduled transmission time, the scheduled transmission time selection portion 13 writes “2022, 1/15, 10:00” into the “scheduled transmission time” field of the record detected from the table of the transmission-side data storage portion 11 in the processing of Step Sa1, as shown in part (b) of FIG. 8. The scheduled transmission time selection portion 13 generates the character string “This message will be sent at 10:00 on 1/15” based on the entered “2022, 1/15, 10:00”. In the processing of Step Sa1, the scheduled transmission time selection portion 13 generates a scheduled transmission time response signal including the character string “This message will be sent at 10:00 on 1/15”, with the user identification information of “User A” written in the “sender identification information” field of the record detected from the table of the transmission-side data storage portion 11 serving as the transmission destination. The scheduled transmission time selection portion 13 transmits the generated scheduled transmission time response signal to the transmission-side terminal device 2 via the transmission processing portion 42 (Step S18).

The scheduled transmission time reception portion 203 of the transmission-side terminal device 2 receives the scheduled transmission time response signal from the server device 1 via the reception processing portion 24. The scheduled transmission time reception portion 203 reads out the character string “This message will be sent at 10:00 on 1/15” contained in the received scheduled transmission time response signal. The scheduled transmission time reception portion 203 displays the read character string “This message will be sent at 10:00 on 1/15” in the scheduled transmission time display area 66 of the message creation area 63 of the message exchange screen 60 displayed on the display portion 22, as shown in part (c) of FIG. 14 (Step S19).

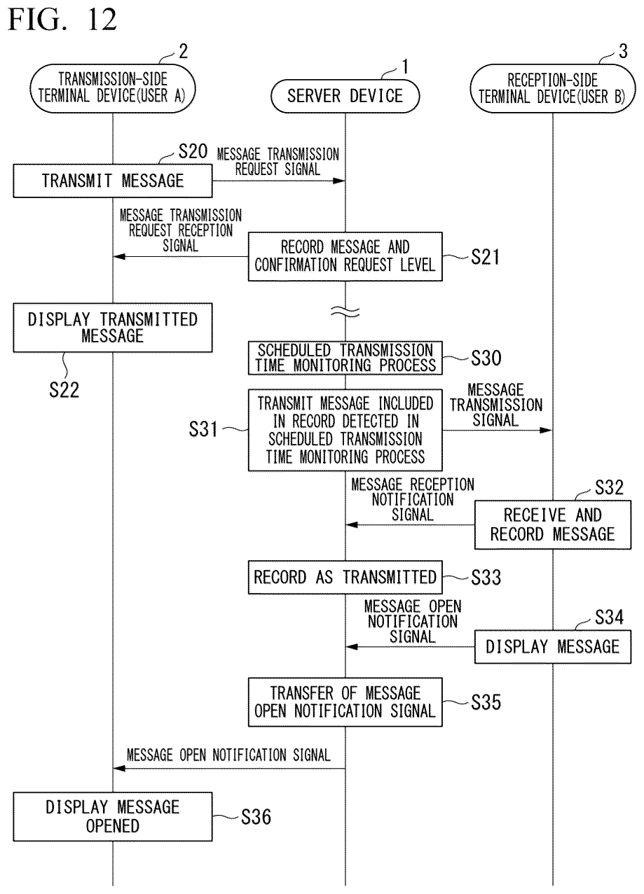

After the process shown in FIG. 11, the process shown in FIG. 12 is carried out. User A refers to “This message will be sent at 10:00 on 1/15” displayed in the scheduled transmission time display area 66, and then performs an operation to press the send button 67 via the operation portion 23. Furthermore, when the user A refers to “This message will be sent at 10:00 on 1/15” displayed in the scheduled transmission time display area 66, if for example it is inconvenient for the message data to be transmitted to the reception-side terminal device 3 at 10:00 on January 15, he or she may again use the operation portion 23 to press the confirmation request level selection button 65 in the message creation area 63 to change the confirmation request level to be specified. In this case, the processes from Step S12 onwards are carried out again.

The message transmission portion 204 of the transmission-side terminal device 2, upon receiving an instruction signal from the operation portion 23 indicating that the send button 67 has been pressed, performs the following process. That is, the message transmission portion 204 acquires the user identification information of “user B” displayed in the message exchange partner display area 61 of the message exchange screen 60 as the recipient identification information. The message transmission portion 204 acquires “user A” stored in the storage portion 205 as its own user identification information as the sender identification information. The message transmission portion 204 obtains the message data displayed in the message input area 64. The message transmission portion 204 acquires the message identification information “0010” associated with the message data displayed in the message input area 64 from the message screen display processing portion 201. The message transmission portion 204 acquires the confirmation request level data of “in the morning”, which indicates the confirmation request level displayed at the position of the confirmation request level selection button 65. The message transmission portion 204 generates a message transmission request signal including the acquired sender identification information of “user A”, recipient identification information of “user B”, message identification information of “0010”, message data, and confirmation request level data of “in the morning”, with the transmission destination set to the server device 1. The message transmission portion 204 transmits the generated message transmission request signal to the server device 1 via the transmission processing portion 25 (Step S20).

The message reception portion 16 of the server device 1 receives the message transmission request signal from the transmission-side terminal device 2 via the reception processing portion 41. The message reception portion 16 detects from the table in the transmission-side data storage portion 11 the record corresponding to the combination of the sender identification information of “user A”, the recipient identification information of “user B”, and the message identification information of “0010” contained in the received message transmission request signal. As shown in part (c) of FIG. 8, the message reception portion 16 writes the message data included in the message transmission request signal into the “message” field of the detected record. The message reception portion 16 rewrites the confirmation request level data written in the “confirmation request level” field of the detected record to the confirmation request level data included in the message transmission request signal.

The message reception portion 16 generates a message transmission request acceptance signal that includes the recipient identification information of “user B” and the message identification information of “0010” contained in the message transmission request signal, with the user identification information of “user B” serving as the transmission destination. The message reception portion 16 transmits the generated message transmission request acceptance signal to the transmission-side terminal device 2 via the transmission processing portion 42 (Step S21). The message transmission portion 204 of the transmission-side terminal device 2, upon receiving the message transmission request acceptance signal from the server device 1 via the reception processing portion 24, displays information indicating that the message has been transmitted, superimposed on the message exchange screen 60 displayed on the display portion 22 (Step S22).

The message transmission portion 17 of the server device 1 performs the following process as a scheduled transmission time monitoring process. That is, the message transmission portion 17 outputs a time acquisition request signal to the clock portion 18 at regular intervals to acquire time data. Each time the message transmission portion 17 acquires time data from the clock portion 18, it determines whether there is a record in which the scheduled transmission time written in the “scheduled transmission time” field of each record in the table of the transmission-side data storage portion 11 is on or after the time indicated in the time data acquired from the clock portion 18. If it is determined that no corresponding record exists, the message transmission portion 17 repeatedly performs a process of outputting a time acquisition request signal to the clock portion 18 at regular intervals (Step S30).

If the message transmission portion 17 determines that a corresponding record exists, it performs the following process. For example, assume that at a certain point in time, the time indicated by the time data acquired by the message transmission portion 17 from the clock portion 18 is “January 15, 2022, 10:00”. In this case, if the message transmission portion 17 determines that the record shown in part (c) of FIG. 8, with “user A” as the “Sender identification information” field, “user B” as the “Recipient identification information” field, “0010” as the “Message identification information” field, and “2022, 1/15, 10:00” as the “Scheduled transmission time” field, is the target record, it will conclude that a corresponding record exists. The message transmission portion 17 reads out the user identification information of “user A” written in the “Sender identification information” field of the record subject to determination, the message identification information of “0010” written in the “Message identification information” field, and the message data contained in the “Message” field. The message transmission portion 17 generates a message transmission signal including the read user identification information of “user A,” the message identification information of “0010,” and the message data, with the user identification information of “user B” written in the “Recipient identification information” field of the record subject to determination as the transmission destination. The message transmission portion 17 transmits the generated message transmission signal to the reception-side terminal device 3 via the transmission processing portion 42 (Step S31).

The message reception portion 305 of the reception-side terminal device 3 receives the message transmission signal transmitted by the server device 1 via the reception processing portion 34. The message reception portion 305 reads out the user identification information of “user A”, the message identification information of “0010”, and the message data contained in the message transmission signal. The message reception portion 305 associates the read user identification information of “user A” with the message identification information of “0010” and the message data, and further associates information indicating an unread status, writes the information to the storage portion 306, and displays on the display portion 32 information indicating that the message has been received. The message reception portion 305, based on the received message transmission signal and its own user identification information stored in the storage portion 306, generates a message reception notification signal that includes the sender identification information of “user A,” recipient identification information of “user B,” and message identification information of “0010,” with the transmission destination set to the server device 1. The message reception portion 305 transmits the generated message reception notification signal to the server device 1 via the transmission processing portion 35 (Step S32).

The message transmission portion 17 of the server device 1 receives the message reception notification signal transmitted by the reception-side terminal device 3 via the reception processing portion 41. The message transmission portion 17 reads out the sender identification information of “user A”, the recipient identification information of “user B”, and the message identification information of “0010” contained in the received message reception notification signal. The message transmission portion 17 detects a record from the table in the transmission-side data storage portion 11 based on the read sender identification information of “user A,” the recipient identification information of “user B,” and the message identification information of “0010,” and rewrites “2022, 1/15, 10:00”, which is written in the “scheduled transmission time” field of the detected record to information indicating that the message has been sent (Step S33). In addition, the table in the transmission-side data storage portion 11 may further include a “sent time” field, and the actual time at which the message data of a record that has already been sent may be written in the “sent time” field. In this way, by referring to the table in the transmission-side data storage portion 11, the order in which the message data was transmitted can be identified.

By rewriting the contents of the “scheduled transmission time” field to information indicating that the record has been sent, the processing for that record is completed, and in the scheduled transmission time monitoring process performed thereafter in Step S30, the message transmission portion 17 will not detect that record. If the reception-side terminal device 3 is, for example, offline, since the process of Step S32 is not performed, the message transmission portion 17 does not receive the message reception notification signal. In this case, in the scheduled transmission time monitoring process in Step S30 that is performed thereafter, the message transmission portion 17 again detects the record, and the processes in and after Step S31 are performed.

The user B, upon referring to the information displayed on the display portion 32 indicating that a message has arrived, performs the action of pressing the user selection button 51B-1 for “user A” via operation portion 33 on the initial screen 50B shown in part (a) of FIG. 5, which is displayed on the display portion 32. The message screen display processing portion 301, upon receiving an instruction signal from the operation portion 33 indicating that the user selection button 51B-1 has been pressed, reads out from storage portion 306 the message data and message identification information associated with the user identification information of “user A”. The message screen display processing portion 301 displays the message data on the display portion 32 in order according to the message identification information. This allows the user B to check the contents of the message sent from the user A.

If the message screen display processing portion 301 displays on the display portion 32 information indicating the unread state, the user identification information of “user A”, and the message data associated with the message identification information of “0010”, the message screen display processing portion 301 performs the following process. The message screen display processing portion 301 deletes, from the storage portion 306, the information indicating the unread state that is associated with the message data. The message screen display processing portion 301 acquires, from the storage portion 306, the user identification information of “user A” associated with the message data, as sender identification information. The message screen display processing portion 301 acquires, from the storage portion 306, the message identification information “0010” associated with the message data. The message screen display processing portion 301 acquires the user identification information of “user B” stored in the storage portion 306 as its own user identification information as the recipient identification information. The message screen display processing portion 301 generates a message open notification signal that includes the acquired sender identification information of “user A”, recipient identification information of “user B”, and message identification information of “0010”, with the server device 1 as the transmission destination. The message screen display processing portion 301 transmits the generated message open notification signal to the server device 1 via the transmission processing portion 35 (Step S34).

The message open notification transfer processing portion 19 of the server device 1 receives the message open notification signal transmitted by the reception-side terminal device 3 via the reception processing portion 41. The message open notification transfer processing portion 19 transmits the received message open notification signal to the transmission-side terminal device 2 via the transmission processing portion 42, with the user identification information of “user A” contained as sender identification information in the received message open notification signal as the transmission destination (Step S35).

The message screen display processing portion 201 of the transmission-side terminal device 2 receives the message open notification signal from the server device 1 via the reception processing portion 24. Based on the recipient identification information of “user B” and the message identification information of “0010” contained in the received message open notification signal, the message screen display processing portion 201 displays on the display portion 22 information indicating that user B has confirmed the message data whose message identification information is “0010” (Step S36). This allows the user A to ascertain that user B has confirmed the message data that user A sent.

When the transmission-side terminal device 2 transmits message data to the reception-side terminal device 3 via the server device 1, the following becomes possible. That is, the user A, who is the sender of the message data, can set in the server device 1 a confirmation request level indicating the urgency of the message data, for example, a deadline by which the message data should be confirmed. The user B, who is the recipient of the message data, can set in advance in the server device 1 a confirmable time period during which the message data can be confirmed. The server device 1 can select the optimum scheduled transmission time for transmitting the message data, taking into consideration the confirmation request level and the confirmable time period. In other words, the server device 1 can vary the time at which the message data is transmitted to the reception-side terminal device 3, taking into consideration the convenience of the sender, such as the time by which the message data should be checked, and the convenience of the receiver, such as when the message data can be checked. This allows, for example, the recipient, user B, to receive non-urgent message data all at once during the confirmable time period that he or she has set. Therefore, it is possible to reduce a decline in work efficiency or forgetting to reply, which can occur due to the frequent arrival of message data, and to prevent the recipient, user B, from experiencing so-called “chat fatigue”. In response to this, the sender, user A, can send the message data in a time period that is convenient for him or her. This makes it possible for the sender to send a message avoiding time periods that are inconvenient for the recipient, even if the sender does not know the exact time period in which the recipient will be able to check the message.

In addition, the server device 1 notifies the transmission-side terminal device 2 of the selected scheduled transmission time, so that the sender, user A, can know when the message data will be received at the reception-side terminal device 3 before sending the message data. Therefore, the sender, user A, can know when the receiver, user B, plans to check the message data, and the sender, user A, can change the confirmation request level using the notified scheduled transmission time as a guide.

In the technique disclosed in Patent Document 1, message transmission/reception application software installed in the sender's terminal device determines whether or not a set transmission time has passed. Therefore, unless the sender's terminal device is turned on and connected to the communication network at the time of sending, the message cannot be transmitted at the time of sending. In contrast to this, in the above example embodiment, the server device 1 temporarily stores the message data transmitted by the transmission-side terminal device 2. Even if the transmission-side terminal device 2 is not running, the server device 1 transmits the stored message data to the reception-side terminal device 3 once the scheduled transmission time has passed. Therefore, the message transmission/reception system 100 including the server device 1 solves the problem in the technology disclosed in Patent Document 1, in that a message cannot be sent at the transmission time unless the sender's terminal device is turned on and connected to the communication network at the transmission time.

### Other Configuration Examples

In the above example embodiment, examples of confirmation request levels designated by the sender, user A, at the transmission-side terminal device 2 are “immediately,” “in the morning,” “today,” “this week,” and “no reply required”. Among these, “in the morning”, “today”, and “this week” are confirmation request levels indicating a period during which the recipient is requested to confirm the message data, and various periods may be applied. For example, a confirmation request level such as “within this month” may be included, or a confirmation request level such as until a specified time or until a specified date may be included.

In the above example embodiment, the confirmable time period set by the recipient, user B, in the reception-side terminal device 3 is a time period represented by a start time and an end time, for example, “10:00-11:00”. In addition, the start time and end time are not limited to times specified by hours and minutes, but may be times obtained by adding the year, month, and day, or the month and day, or the day, to hours and minutes, and may further include the day of the week and may include units of seconds. In the case of including units of seconds, in order for the message transmission portion 17 to perform a comparison with the scheduled transmission time, including units of seconds, the clock portion 18 needs to output time data indicating the date, day of the week, hour, minute, and second at the time when the time acquisition request signal was received.

Furthermore, for the confirmable time period, the year may be expressed in the western calendar, such as “2022,” or in the Japanese calendar, such as “Reiwa 4,” and the time may be expressed in the 24-hour system, such as “23:00”, or in the 12-hour system, such as “11:00 p.m.” In this case, when the scheduled transmission time selection portion 13 performs the determination process of steps Sa5, Sa7, and Sa9 of the scheduled transmission time selection process shown in FIG. 13, if the confirmable time period data contains a Japanese calendar date, it must convert it to the western calendar date, and if it contains the 12-hour format, it must convert it to the 24-hour format.

In the above example embodiment, the confirmable time period is set by the user B, who is the recipient, operating the operation portion 33. In contrast to this, the confirmable time period designation portion 302 of the reception-side terminal device 3 may, for example, access a schedule management application that stores the schedule data of the recipient, user B, and select a confirmable time period from among the user B's free time period. The schedule management application may be installed in the reception-side terminal device 3, or in an external device that the reception-side terminal device 3 can access.

In addition, the confirmable time period designation portion 302 of the reception-side terminal device 3 may, for example, access a presence detection application installed in the reception-side terminal device 3 to obtain the location of the recipient, user B, and select the confirmable time period based on information indicating the location of user B. In addition, the confirmable time period designation portion 302 of the reception-side terminal device 3 may periodically access a schedule management application or a presence detection application to overwrite the confirmable time period that is selected in the confirmable time period storage portion 303. This makes it possible to dynamically change the confirmable time period in response to changes in user B's situation.

In the above example embodiment, in the determination process of Step Sa5 of the scheduled transmission time selection process shown in FIG. 13, it is assumed that the time when the scheduled transmission time selection portion 13 of the server device 1 performs the determination process is already a time in the afternoon. In this case, the scheduled transmission time selection portion 13 may perform the determination process by interpreting the period indicated by “in the morning” in the confirmation request level data as the period of “in the morning” on the following day. Furthermore, in this case, if the scheduled transmission time selection portion 13 adds date information to the scheduled transmission time to be written in the “scheduled transmission time” field of the corresponding record in the table of the transmission-side data storage portion 11 in the processing of Step S18, it is necessary to add the date of the following day, not the date of the day on which the processing is being performed.

In the above example embodiment, the message transmission portion 204 of the transmission-side terminal device 2 may generate a message transmission request signal that does not include a confirmation request level in the processing of Step S20, and transmit the generated message sending request signal to the server device 1 via the transmission processing portion 25. In this case, the message reception portion 16 of the server device 1 will not perform the process of rewriting the confirmation request level data written in the “confirmation request level” field of the detected record.

In the above example embodiment, an example is shown in which the server device 1 is realized by a single device, but the functional units of the server device 1 may be distributed across multiple server devices, and the server device 1 may be realized as a server system such as the one below that includes multiple such server devices. For example, the server system may be composed of a plurality of server devices connected to a communication network 4, such as a first service device including a transmission-side data storage portion 11, a second server device including a confirmable time period storage portion 14, a third server device including a confirmation request level reception portion 12, a scheduled transmission time selection portion 13, a confirmable time period acquisition portion 15, and a clock portion 18, and a fourth server device including a message reception portion 16, a message transmission portion 17, the clock portion 18, and a message open notification transfer processing portion 19, with each of the first to fourth server devices being including a reception processing portion 41 and a transmission processing portion 42.

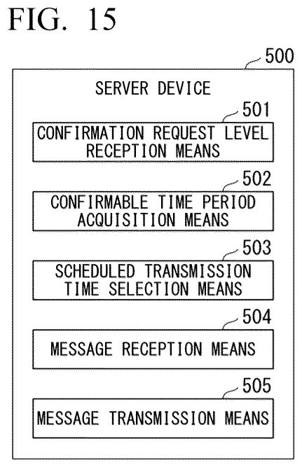

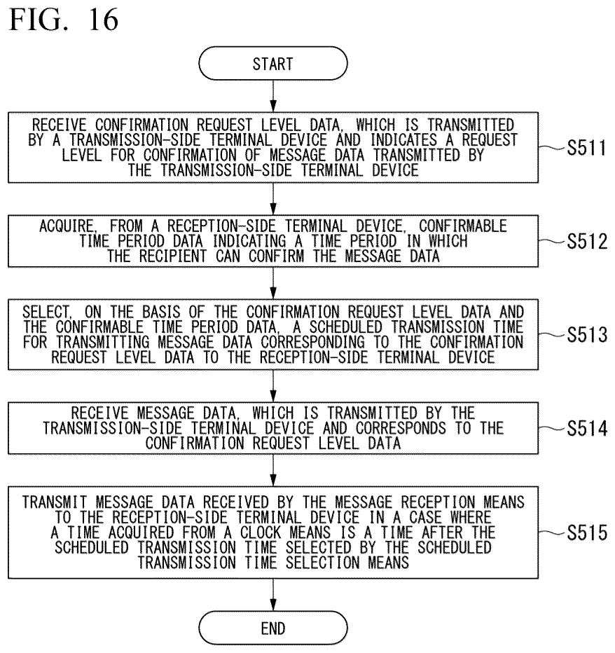

FIG. 15 is a block diagram showing a configuration of a server device 500 according to the present disclosure, and FIG. 16 is a flowchart showing the flow of processing performed by the server device 500. As shown in FIG. 15, the server device 500 includes a confirmation request level reception means 501, a confirmable time period acquisition means 502 (confirmable time period reception means), a scheduled transmission time selection means 503, a message reception means 504, and a message transmission means 505. As shown in FIG. 16, in the server device 500, the confirmation request level reception means 501 receives confirmation request level data, which is transmitted by a transmission-side terminal device and indicates a request level for confirmation of message data transmitted by the transmission-side terminal device (Step S511). The confirmable time period acquisition means 502 acquires, from a reception-side terminal device, confirmable time period data indicating a time period in which the recipient can confirm the message data (Step S512). The scheduled transmission time selection means 503 selects, on the basis of the confirmation request level data and the confirmable time period data, a scheduled transmission time for transmitting message data corresponding to the confirmation request level data to the reception-side terminal device (Step S513). The message reception means 504 receives the message data, which is transmitted by the transmission-side terminal device and corresponds to the confirmation request level data (Step S514). The message transmission means 505 transmits the message data received by the message reception means 504 to the reception-side terminal device when a time acquired from a clock means is a time on or after the scheduled transmission time selected by the scheduled transmission time selection means 503 (Step S515).

The above-mentioned server device 1, transmission-side terminal device 2, and reception-side terminal device 3 have a computer system therein, and a program for realizing the functions of the confirmation request level reception portion 12, scheduled transmission time selection portion 13, confirmable time period acquisition portion 15, message reception portion 16, message transmission portion 17, message open notification transfer processing portion 19, and the message screen display processing portion 201, confirmation request level designation portion 202, scheduled transmission time reception portion 203, and message transmission portion 204 of the transmission message processing portion 21, and the message screen display processing portion 301, confirmable time period designation portion 302, confirmable time period acquisition request acceptance portion 304, and message reception portion 305 of the received message processing portion 31 may be recorded on a computer-readable recording medium, and the program recorded on this recording medium may be read into and executed by a computer system to perform the processing described with reference to FIGS. 11 to 13.

The above program may be for realizing some of the above-mentioned functions. Furthermore, the above-mentioned functions may be realized in combination with a program already recorded in the computer system, that is, a so-called differential file (differential program).

Although the example embodiments of the present disclosure have been described in detail above with reference to the drawings, the specific configuration is not limited to these example embodiments, and also includes designs within the scope of the gist of this disclosure.

Hereinbelow, some of all of the above example embodiments may also be described as follows in the supplementary notes, but not limited to the following.

### Supplementary Note 1

A server device comprising:
a confirmation request level reception means for receiving, from a transmission-side terminal device, confirmation request level data indicating a request level for confirmation of message data transmitted by the transmission-side terminal device;
a confirmable time reception means for receiving, from a reception-side terminal device, confirmable time period data indicating a time period during which the recipient is able to confirm message data;
a scheduled transmission time selection means for selecting a scheduled transmission time for transmitting message data to the reception-side terminal device, based on the confirmation request level data and the confirmable time period data;
a message reception means for receiving, from the transmission-side terminal device, message data corresponding to the confirmation request level data; and
a message transmission means for transmitting the message data received by the message reception means to the reception-side terminal device in a case where a time acquired from a clock means is a time on or after the scheduled transmission time selected by the scheduled transmission time selection means.

### Supplementary Note 2

The server device according to supplementary note 1, wherein the scheduled transmission time selection means, in a case where the confirmation request level data indicates immediate confirmation, selects a time acquired from the clock means as the scheduled transmission time.

### Supplementary Note 3

The server device according to supplementary note 1 or 2, wherein the scheduled transmission time selection means, in a case where the confirmation request level data indicates a period and a range of the period includes the time period indicated by the confirmable time period data, selects an earliest time within the time period indicated by the confirmable time period data as the scheduled transmission time.

### Supplementary Note 4

The server device according to any one of supplementary notes 1 to 3, wherein the scheduled transmission time selection means, in a case where the confirmation request level data indicates a period and a range of the period does not include the time period indicated by the confirmable time period data, selects a time acquired from the clock means as the scheduled transmission time.

### Supplementary Note 5

The server device according to any one of supplementary notes 1 to 4, wherein the scheduled transmission time selection means, in a case where the confirmation request level data indicates that a reply is not required, selects an earliest time among the time period indicated by the confirmable time period data as the scheduled transmission time.

### Supplementary Note 6

The server device according to any one of supplementary notes 1 to 5, wherein the scheduled transmission time selection means transmits the selected scheduled transmission time to the transmission-side terminal device.

### Supplementary Note 7

A transmission-side terminal device comprising:
a confirmation request level designation means for transmitting confirmation request level data to a server device, the confirmation request level data being designated by a sender and indicating a request level for confirmation of message data to be transmitted; and
a message transmission means for transmitting the message data to the server device.

### Supplementary Note 8

The transmission-side terminal device according to supplementary note 7, further comprising:
a scheduled transmission time reception means for receiving from the server device and presenting to the sender data indicating a scheduled transmission time of message data, the scheduled transmission time being selected by the server device based on the confirmation request level data and confirmable time period data indicating a time period during which the recipient is able to confirm message data, the server device having received the confirmable time period data from a reception-side terminal device.

### Supplementary Note 9

A reception-side terminal device comprising:
a confirmable time designation means for transmitting, to a server device, confirmable time period data indicating a time period during which a recipient is able to confirm message data; and
a message reception means for receiving message data.

### Supplementary Note 10

A message transmission/reception system comprising:
the server device according to any one of supplementary notes 1 to 6;
the transmission-side terminal device according to supplementary note 7 or 8; and
the reception-side terminal device according to supplementary note 9.

### Supplementary Note 11

A message transmission/reception method of a server device, comprising:
a confirmation request level reception step of receiving, from a transmission-side terminal device, confirmation request level data indicating a request level for confirmation of message data transmitted by the transmission-side terminal device;
a confirmable time reception step of receiving, from a reception-side terminal device, confirmable time period data indicating a time period during which the recipient is able to confirm the message data;
a scheduled transmission time selection step of selecting a scheduled transmission time for transmitting message data to the reception-side terminal device, based on the confirmation request level data and the confirmable time period data;
a message reception step of receiving, from the transmission-side terminal device, message data corresponding to the confirmation request level data; and
a message transmission step of transmitting the message data received in the message reception step to the reception-side terminal device in a case where a time acquired from a clock means is a time on or after the scheduled transmission time selected in the scheduled transmission time selection step.

### Supplementary Note 12

The message transmission/reception method of a server device according to supplementary note 11,
wherein the scheduled transmission time selection step, in a case where the confirmation request level data indicates immediate confirmation, selects a time acquired from the clock means as the scheduled transmission time.

### Supplementary Note 13

The message transmission/reception method of a server device according to supplementary note 11 or 12,
wherein scheduled transmission time selection step, in a case where the confirmation request level data indicates a period and a range of the period includes the time period indicated by the confirmable time period data, selects an earliest time within the time period indicated by the confirmable time period data as the scheduled transmission time.

### Supplementary Note 14

The message transmission/reception method of a server device according to any one of supplementary notes 11 to 13, wherein the scheduled transmission time selection step, in a case where the confirmation request level data indicates a period and a range of the period does not include the time period indicated by the confirmable time period data, selects a time acquired from the clock means as the scheduled transmission time.

### Supplementary Note 15

The message transmission/reception method of a server device according to any one of supplementary notes 11 to 14, wherein the scheduled transmission time selection step, in a case where the confirmation request level data indicates that a reply is not required, selects an earliest time among the time period indicated by the confirmable time period data as the scheduled transmission time.

### Supplementary Note 16

The message transmission/reception method of a server device according to any one of supplementary notes 11 to 15, wherein the scheduled transmission time selection step transmits the selected scheduled transmission time to the transmission-side terminal device.

### Supplementary Note 17

A message transmission method of a transmission-side terminal device comprising:
a confirmation request level designation step of transmitting confirmation request level data to a server device, the confirmation request level data being designated by a sender and indicating a request level for confirmation of message data to be transmitted; and
a message transmission step of transmitting the message data to the server device.

### Supplementary Note 18

The message transmission method of the transmission-side terminal device according to supplementary note 17, further comprising:
a scheduled transmission time reception step of receiving from the server device and presenting to the sender data indicating a scheduled transmission time of message data, the scheduled transmission time being selected by the server device based on the confirmation request level data and confirmable time period data indicating a time period during which the recipient is able to confirm message data, the server device having received the confirmable time period data from a reception-side terminal device.

### Supplementary Note 19

A message reception method of a reception-side terminal device comprising:
a confirmable time designation step of transmitting, to a server device, confirmable time period data indicating a time period during which the recipient is able to confirm message data; and
a message reception step of receiving the message data.

### Supplementary Note 20

A message transmission/reception method of a message transmission/reception system comprising:
the message transmission/reception method of a server device according to any one of supplementary notes 11 to 16;
the message transmission method of a transmission-side terminal device according to supplementary note 17 or 18; and
the message reception method of a reception-side terminal device according to supplementary note 19.

### Supplementary Note 21

A program causing a computer to carry out the method according to any one of supplementary notes 11 to 20.

Priority is claimed on Japanese Patent Application No. 2022-130539, filed on Aug. 18, 2022, the content of which is incorporated herein in by reference.

### INDUSTRIAL APPLICABILITY

The present disclosure is applicable to instant messengers.

### REFERENCE SIGNS LIST

100 Message transmission/reception system
1 Server device
11 Transmission-side data storage portion
12 Confirmation request level reception portion
13 Scheduled transmission time selection portion
14 Confirmable time period storage portion
15 Confirmable time period acquisition portion
16 Message reception portion
17 Message transmission portion
18 Clock portion
19 Message open notification transfer processing portion
41 Reception processing portion
42 Transmission processing portion
2 Transmission-side terminal device
21 Transmission message processing portion
22 Display portion
23 Operation portion
24 Reception processing portion
25 Transmission processing portion
201 Message screen display processing portion
202 Confirmation request level designation portion
203 Scheduled transmission time reception portion
204 Message transmission portion
205 Storage portion
3 Reception-side terminal device
31 Received message processing portion
32 Display portion
33 Operation portion
34 Reception processing portion
35 Transmission processing portion
301 Message screen display processing portion
302 Confirmable time period designation portion
303 Confirmable time period storage portion
304 Confirmable time period acquisition request acceptance portion
305 Message reception portion
306 Storage portion

What is claimed is:

1. A server device comprising:
a memory configured to store instructions; and
at least one processor configured to execute the instructions to:
receive, from a transmission-side terminal device, confirmation request level data indicating a request level for confirmation of message data transmitted by the transmission-side terminal device;
receive, from a reception-side terminal device, confirmable time period data indicating a time period during which the recipient is able to confirm message data;
select a scheduled transmission time for transmitting message data to the reception-side terminal device, based on the confirmation request level data and the confirmable time period data;
receive, from the transmission-side terminal device, message data corresponding to the confirmation request level data; and
transmit the received message data to the reception-side terminal device in a case where a time acquired from a clock is a time on or after the selected scheduled transmission time.

2. The server device according to claim 1, wherein
the at least one processor is configured to execute the instructions to,
in a case where the confirmation request level data indicates immediate confirmation,
select a time acquired from the clock as the scheduled transmission time.

3. The server device according to claim 1, wherein
the at least one processor is configured to execute the instructions to,
in a case where the confirmation request level data indicates a period and a range of the period includes the time period indicated by the confirmable time period data,
select an earliest time within the time period indicated by the confirmable time period data as the scheduled transmission time.

4. The server device according to claim 1, wherein
the at least one processor is configured to execute the instructions to,
in a case where the confirmation request level data indicates a period and a range of the period does not include the time period indicated by the confirmable time period data,
select a time acquired from the clock as the scheduled transmission time.

5. The server device according to claim 1, wherein
the at least one processor is configured to execute the instructions to,
in a case where the confirmation request level data indicates that a reply is not required,
select an earliest time among the time period indicated by the confirmable time period data as the scheduled transmission time.

6. The server device according to claim 1, wherein
the at least one processor is configured to execute the instructions to
transmit the selected scheduled transmission time to the transmission-side terminal device.

7. A transmission-side terminal device comprising:
a memory configured to store instructions; and
at least one processor configured to execute the instructions to:
transmit confirmation request level data to a server device, the confirmation request level data being designated by a sender and indicating a request level for confirmation of message data to be transmitted;
receive, from the server device, data indicating a scheduled transmission time at which the message data is to be transmitted to a reception-side terminal device, and present the received data to the sender; and
transmit the message data to the server device,
wherein
the scheduled transmission time is a scheduled time at which the message data is to be transmitted to the reception-side terminal device,
wherein
the scheduled transmission time is selected by the server device based on the confirmation request level data and confirmable time period data,
wherein
the confirmable time period data indicates a time period during which the recipient is able to confirm message data, and
wherein
the confirmable time period data is received by the server device from the reception-side terminal device.

8. (canceled)

9. A reception-side terminal device comprising:
a memory configured to store instructions; and
at least one processor configured to execute the instructions to:
transmit, to a server device, confirmable time period data indicating a time period during which a recipient is able to confirm message data; and
receive message data and present the message data to the recipient,
wherein
the message data is received from the server device at or after the scheduled transmission time that is selected by the server device based on confirmation request level data and the confirmable time period data,
wherein
the confirmation request level data is designated by a sender and indicates a request level for confirmation of the message data, and
wherein
the confirmation request level data is received by the server device from the transmission-side terminal device.

10. A message transmission/reception system comprising:
the server device according to claim 1;
a transmission-side terminal device, comprising:
a second memory configured to store second instructions; and
at least one second processor configured to execute the second instructions to:
transmit the confirmation request level data to the server device, the confirmation request level data being designated by a sender;
receive, from the server device, data indicating the scheduled transmission time and present the received data to the sender; and
transmit the message data to the server device,
wherein
the scheduled transmission time is a scheduled time at which the message data is to be transmitted to the reception-side terminal device; and
a reception-side terminal device comprising:
a third memory configured to store third instructions; and
at least one third processor configured to execute the third instructions to:
transmit, to the server device, the confirmable time period data; and
receive message data from the server device and present the message data to the recipient.

11-21. (canceled)
